(19) United States
(12) Patent Application Publication
(10) Pub. No.: US 2013/0113133 A1
(43) Pub. Date: May 9, 2013

(54) Impregnation Assembly and Method for Manufacturing a Composite Structure Reinforced with Long Fibers

(71) Applicant: Sanjay P. Kashikar, Kelmis (BE)

(72) Inventor: Sanjay P. Kashikar, Kelmis (BE)

(73) Assignee: 3B-FIBREGLASS SPRL, Battice (BE)

(21) Appl. No.: 13/641,932

(22) PCT Filed: Apr. 19, 2011
(86) PCT No.: PCT/EP2011/056228

§ 371 Date: Dec. 11, 2012

(30) Foreign Application Priority Data
Apr. 19, 2010 (EP) 10160262.1
Apr. 19, 2010 (EP) 10160270.4

(51) Int. Cl. B05C 3/12; B29C 53/16; B05D 1/18; B32B 5/16; B32B 27/12

(52) U.S. Cl. 264/136; 428/221; 118/420; 427/434.6; 427/314

(57) ABSTRACT

The present invention provides an impregnation system suitable for impregnating filaments continuously with an impregnating substance, said system may comprise an impregnation assembly comprising (a) at least one axial passageway for the filaments having an entrance end and an exit end and (b) at least one passageway for the impregnating substance having at least one inlet for the impregnating substance and at least two outlets for the impregnating substance leading into the passageway for the filaments via the outlets for the impregnating substance, wherein the passageway for the filaments has an oblong cross-section at the outlet point for the impregnating substance, and the at least two outlets for the impregnating substance have an oblong cross-section, and are disposed essentially opposite to each other, at the opposite widths of the passageway for the filaments. Thus, the present invention proposes an in-line system for manufacturing continuous fiber reinforced thermoplastic structure which comprises a simple device to provide strands in spread filaments form without using high friction or tension on the strand or filaments so as to ease the impregnation step and to allow higher line speeds and lower cycle times.

### TECHNICAL FIELD

The present invention relates to an impregnation assembly and a method for manufacturing continuous fiber reinforced composite structures, which provides improvements in productivity and product properties such as quality, aesthetics and flexibility, as well as environmental and cost advantages. More particularly, the invention relates to a new cross-head die assembly designed for impregnating continuous filaments or fibers with an impregnating substance such as a polymer matrix. The present invention also relates to a thermoplastic composite such as a prepreg, reinforced with continuous fibers such as glass, carbon or graphite fibers, which is suitable for use in a subsequent processing with cost, speed and environmental advantages. The present invention particularly relates to a method and system which uses an impregnation means comprising a step of sandwiching the multi-filaments with two portions of the impregnating substance at the initial meeting point of the filaments and the impregnating substance. The present invention further relates to a method and a system for an in-line manufacturing intermediate such as rods, tapes, cut pellets or final composite structure reinforced with continuous long fibers, such as pipes, cylinders, tubes and panels.

### BACKGROUND FOR THE INVENTION

Polymers can be reinforced by fibrous materials, such as glass fibers, to provide them with additional strength. Reinforced polymer materials, also called composites, have wide applications in, for example, the aerospace, automotive, chemical, and sporting goods industries.

Continuous fibers are employed in various composite manufacturing processes. Typical processes include pultrusion, filament winding, wire coating, tape manufacturing, pre- and post-preg manufacturing and others like extrusion-compression molding, extrusion-injection molding, pushtrusion and push-pultrusion processes.

In thermoset composites, pultrusion is a well established process utilizing mainly continuous reinforcement strands to produce linear composite structures. Commonly, the fiber strands are passed through an open bath consisting of chemicals meant for impregnating the fibers, then through a heated die for shaping and curing and then pulling the cured part on a continuous basis.

Although the thermosetting precursor impregnating formulation can have low viscosity, which is facilitating the wetting of the fibers, this conventional impregnating open bath exposes large surface to atmosphere and does not restrict odour and emission of hazardous, volatile chemicals and solvents that may be present in the impregnating precursor formulations. Another disadvantage of open bath is, that the strands soaked with resin are generally squeezed under friction to remove excess resin picked up by the strands. Over time, the squeezing friction can lead to filament rupture, thus creating fuzz in the bath and, thereby, hindering smooth wetting of fibers. Also, resin tends to build up on the squeezer and to becomes cured and hard, hence causing fiber breaks. Further, the big open baths pose difficulties in controlling the pot life of the thermosetting impregnating formulation leading to inconsistent viscosity and wetting of the strands. Also, squeezing out the excess resin mix from the soaked strands has a tendency to limit the achievable fiber to matrix ratio which may not be optimum.

An impregnation assembly and system according to the present invention overcomes these problems.

Although thermosetting composites provide many advantages, once cured, they can no longer be softened, reshaped or given curve. On the other hand, thermoplastic materials offer several benefits over thermosetting and steel material, such as lighter weight, non-corroding, unlimited raw material shelf life, moldability, higher fracture elongation, higher impact or fracture toughness, recyclability, speedy processes and cleaner manufacturing environment. Therefore, process development, especially in the case of thermoplastic matrix materials, is of great interest to the industry.

In order to reach optimum performance of composite parts, the reinforcement fibers need to be well wetted, impregnated and/or dispersed within the matrix. Hence, when continuous fibers are utilised to produce directly pre-pregs or the final reinforced composite parts, the wetting and good impregnation of fibers is important during their processing.

In the case of thermoplastic compositions, however, it is usually more difficult to advantageously impregnate the reinforcing material because of comparatively higher viscosities. Therefore, thermoplastics are known to wet and impregnate the reinforcing fibers at much slower rate as opposed to thermosetting material which have considerably lower initial viscosities. Generally, continuous fiber impregnation processes using thermoplastic material are forced to run at slower rates to ensure acceptable wetting and impregnation of reinforcing fiber material with a thermoplastic matrix. These slow rates are also imposed by the need to avoid breaking of the fibers that are under extremely high pulling forces through the impregnation process. Products with insufficiently wetted fibers can result in poor quality composites, e.g., lacking mechanical strength and aesthetic properties.

Generally, the quality and performance of the part are affected when such processes are run at higher speeds. Namely, due to the much higher viscosities of thermoplastic material, it cannot be adequately penetrated and distributed throughout the strand at high production speed thus leading to unacceptable dispersion of the fibers in the subsequently processed product.

Typically, thermoplastic pre-preg (unidirectional or fabric based) and post-preg (comingled fiber, powder coated strands) materials have been in use for making the final composite parts comprising continuous fibers, but they need consolidation and compaction under heat and pressure for manufacturing composite parts. During laying up, consolidation and compaction, air may get trapped in interlayers. Also, intermingling of resin molecules of two layers may require higher heat, compaction pressure and longer processing time. According to such techniques composite parts can be made at higher rates, but such two-step processes suffer from cost disadvantages, extra thermal history, handling, processing problems and quality issues for the final part to be obtained and seriously limit the flexibility for the users in the formulation package, color and amount of fibers.

Solvent can be used to reduce the viscosity of the thermoplastic matrix. U.S. Pat. No. 4,738,868 discloses a varying process wherein the polymer is dissolved in a solvent and the fiber tow is impregnated with the resulting low viscosity solution. U.S. Pat. No. 6,372,294 discloses an impregnation using a suspension of thermoplastic particles in a bath. In either case, the solvent must be driven off after the impregnation step, resulting in an additional step in the process as well as in an unwanted emission. Moreover, the desired matrix may be insoluble in commonly used solvents or difficult to transform into particle form.

Generally, direct melt impregnation of a fiber strand with molten polymer is possibly preferred option. The composite structures are prepared by passing the fiber strand, which is typically made of continuous fibers, through a passage in a die, allowing impregnation of the fiber strand with a molten thermoplastic resin in the die, and shaping the impregnated fiber bundle to a desired shape such as that of a rod using a shaping die. Particularly, the direct melt impregnation techniques, though slower, are most suitable for in-line impregnation of continuous fibers. High speed, and therefore more economical, wire coating process coats the bundled strands with the molten matrix. For example, such direct melt coating technique is disclosed in the U.S. Pat. No. 3,993,726. The technique, however, has the disadvantage that the fiber strand risks to be coated only from the outside with no appreciable impregnation of the fiber bundle occurring with the matrix resin in the cross-head die. Therefore this technique is not suitable to obtain good in-line impregnation of continuous fibers. Products from such processes, for example thermoplastic pellets reinforced with fibers, when molded, lead to undispersed fiber bundles in the final composite part. In order to improve the fiber dispersion in the final part, such reinforced pellets require molding at higher shear, but that can lead to fiber breakage, fiber length shortening and, therefore, to reduce mechanical performance.

In order to improve the impregnation in a direct melt-impregnation system, the bundled strand is typically forced to undergo opening under friction in a hot-melt polymer vessel.

U.S. Pat. No. 5,268,050 discloses a die assembly using friction bars placed within the molten thermoplastic bath, wherein the friction is applied individually to the continuous fibers over the bars. The fiber strands are passed over and pressed against a series of friction bars in order to open, flatten and spread the strand into filaments so that a majority of individual filaments is exposed to hot-melt thermoplastic polymer, thereby easing the penetration of matrix melt through the filaments. If a compacted fiber bundle is passed through this assembly without friction applied, the expected impregnation quality is poor.

Similarly, U.S. Pat. No. 4,937,028 discloses forming a fiber reinforced product using friction in a hot-melt thermoplastic matrix in order to improve impregnation performance. The friction/tension is applied individually to fibers in a meandering passage provided in the cross-head die when the fiber bundle passes the top and bottom portions of the passage.

Garman patent application DE 44 43 514 A1 also discloses an impregnation process of continuous fibers with molten thermoplastic material for producing fiber-reinforced material, and an impregnation apparatus intended therefore. The apparatus has a meandering passage in its impregnation zone and the thermoplastic material is provided to the meandering passage through feeder outlets located on both sides of the passage. The outlets are positioned offset relative to each other in order to reduce the variation of pressure created on the fibers by injecting the thermoplastic material into the passage. The long meandering curved passage, may allow more contact time and surface between impregnating material and fibers, but can also lead to more friction and thus higher pulling forces and tension, thus increasing the risk of filaments rupture during impregnation. This higher friction in the passage does not allow increase of line speeds without affecting the production and the impregnation quality.

U.S. Pat. No. 5,540,797 discloses a pultrusion apparatus and process for forming thermoplastic impregnated fibers by guiding the fiber tows alternately over and under a plurality of spaced annular rings to alternately spread and converge the fiber tows in order to ensure maximum exposure to the hot-melt impregnation resin in the impregnation vessel. In the manufacturing process of composite structures reinforced with long fibers disclosed in the above references, the opening of bundled fiber strands into multiple filaments occurs mainly by friction in the hot-melt matrix, generating a high level of tension or pulling force on each fiber individually. The combination of friction and tension forces on the fibers, particularly at high temperatures in the hot-melt matrix, may cause fiber breakage leading to fuzz generation. Also, higher tensions can cause the strand to break. Fuzz generation may ultimately lead to die blocking, requiring regular maintenance which in turn affects production costs. Strand breakage may induce a production interruption with all disadvantages connected therewith.

Consequently, conventional processes for impregnation by exposing a fiber reinforcing material to friction and high pulling force in a hot-melt viscous matrix have deficiencies which tend to limit the quality of the product or the speed of manufacturing. The problems become even more severe at higher production speeds or with higher content of reinforcing materials. Therefore, such processes may only be run at much lower and uneconomical speeds.

Accordingly, good wetting of fibers at microscopic level at high production speed with good dispersion of fibers in a reinforced polymer structure remains an ultimate goal.

U.S. Pat. No. 5,073,413 discloses a method for wetting fiber reinforcements with matrix material in a pultrusion process, and an apparatus therefore. The apparatus comprises two enlarged cavities being teardrop shaped, the first teardrop-shaped cavity is for injecting matrix material into fiber reinforcements, the second teardrop-shaped cavity is for degassing the fiber impregnated with matrix material under low-pressure conditions. This method requires complex structures such as the additional cavity for degassing and a vacuum system for producing the low-pressure conditions. Furthermore, the speed of the process is hindered or limited by the degassing step of the process.

It is, therefore, of great interest to develop an improved, simple method for impregnating continuous fibers, which are particularly suitable for in-line impregnation enabling to manufacture reinforced thermoplastic structures in one-step, with improved quality, manufacturing and formulation flexibility, aesthetics, performance, high production speeds and low costs. It is also of great importance to provide an in-line system for manufacturing continuous fiber reinforced thermoplastic structure which comprises a simple device to provide strands in spread filaments form without using high friction or tension on the strand or filaments so as to ease the impregnation step and to allow higher line speeds and lower cycle times.

The present invention also seeks to provide a process for manufacturing filament reinforced composite structures with a novel apparatus for impregnating a continuous long reinforcing fiber material with an impregnating substance having a rather high viscosity at suitable impregnating temperature, more specifically a thermoplastic matrix.

The present invention further proposes a novel in-line system and a method for manufacturing a continuous fiber reinforced composite structure in-line, in particular, by comprising a simple means which may spread the filaments of a strand without applying high friction or tension forces on the strands or filaments. The proposed system enables easier and faster impregnation and also offers formulation flexibility for the manufacturer, including without being limited to adjustment of fiber content, matrix type, color and any additions of process-, performance- and aesthetic enhancement additives.

### SUMMARY OF THE INVENTION

The subject matter of the present invention is defined in the appended independent claims. Preferred embodiments are defined in the dependent claims.

In a first embodiment, the subject matter of the present invention is an impregnation system suitable for impregnating filaments continuously with an impregnating substance, said system may comprise an impregnation assembly comprising (a) at least one axial passageway for the filaments having an entrance end and an exit end and (b) at least one passageway for the impregnating substance having at least one inlet for the impregnating substance and at least two outlets for the impregnating substance leading into the passageway for the filaments via the outlets for the impregnating substance, wherein the passageway for the filaments has an oblong cross-section at the outlet point for the impregnating substance, and the at least two outlets for the impregnating substance have an oblong cross-section, and are disposed essentially opposite to each other, at the opposite widths of the passageway for the filaments.

In particular, the passageway for the filaments of said impregnation assembly has an oblong cross-section with an aspect ratio (AR₍₃₀₎) of at least 2:1 (w₍₃₀₎:h₍₃₀₎), preferably at least 4:1, more preferably at least 8:1, even more preferably at least 20:1, most preferably at least 50:1, at the outlet point for the impregnating substance.

Preferably, the width of each outlet for the impregnating substance into the filament passageway is essentially the same as the one of the filament passageway.

Advantageously, the at least two outlets for the impregnating substance into the passageway for the filaments have an oblong cross-section with an aspect ratio (AR₍₃₂₄₎) of at least 2:1 (w₍₃₂₄₎:h₍₃₂₄₎), preferably at least 3:1, more preferably at least 4:1, even more preferably at least 8:1.

Preferably, the impregnation assembly further comprises (a) an inner die comprising a passage space for filaments, a projection end and an entrance end, and (b) an outer die comprising an inner space, an exit passage, an exit end, and a passage for impregnating substance, wherein the inner die is positioned in the inner space of outer die and the projection end of the inner die is positioned to form the outlets for the impregnating substance, the filament passageway comprises the passage space of the inner die, the exit passage of the outer die, and at least two outlets for the impregnating substance opposite to each other, said passage space and said exit passage being aligned in the direction of the filament passageway.

Preferably, the impregnation assembly further comprises at least one adjusting means controlling the distance between the inner die and the outer die along the axial direction of the filament passageway so as to adjust the size or the aspect ratio of the outlet for the impregnating substance.

More preferably, the inner die comprises at least two die units disposed essentially opposite to each other and each die unit is independently adjustable by an adjusting means comprised in each die unit.

Advantageously, said adjusting means comprises a screw attaching the inner die to the outer die in an adjustable manner.

Alternatively, said adjusting means may consist in pneumatic and/or hydraulic adjusting means.

The impregnation assembly preferably further comprises a shaping die arranged immediately downstream of the exit passage of the outer die, the shaping die comprising at least two die units disposed essentially opposite to each other, and at least one die unit is slidably adjustable in an up or down movement by the adjusting means comprised therein.

Advantageously, said adjusting means of the shaping die comprises an eccentric screw to adjust the distance between the opposite shaping die units.

In one particular embodiment, the impregnation system may further comprise a spreader assembly arranged upstream of the impregnation assembly.

Said spreader assembly may comprise in particular (a) at least one passageway for filaments having an inlet opening for receiving filaments and an outlet opening through which the filaments exit said passageway, (b) a divergent zone within the passageway having an entrance end and an exit end, wherein the section of the exit end is larger than the one of the entrance end and the divergent zone has an oblong cross-section with the aspect ratio at least 2:1, preferably at least 3:1, more preferably at least 4:1, and (c) at least one through hole connected to the passageway at an angle, preferably substantially perpendicular with respect to the longitudinal direction of the passageway, and suitable for introducing air flow thereto.

Preferably, the though hole of the spreader assembly is connected to the passageway for the filament through an outlet for air disposed adjacent to the entrance end of the divergent zone.

Advantageously, the outlet for air has one or more holes smaller than the dimension of the though hole.

In a preferred embodiment of the impregnation system, the passageway of said spreader assembly further comprises an inner channel having a rectilinear shape disposed between the inlet opening of the passageway and the entrance end of the divergent zone.

Preferably, the outlet for air of said spreader assembly is disposed within the inner channel, and more preferably at a point immediately upstream from the entrance end of the divergent zone.

Advantageously, the divergent zone of the said spreader assembly has a top wall, a bottom wall and sidewalls, wherein the sidewalls diverge outwardly from the entrance end toward the exit end, preferably at an angle of from 10° to 50°.

The present invention further is concerned with a method of producing a reinforced composite structure, which according to the first embodiment comprises the steps of (a) supplying two or multiple filaments from one or more source of continuous filaments, (b) arranging said filaments in a plane and (c) subjecting said filaments to at least two flows of the impregnating matrix substance sandwiching and impregnating the filaments within the impregnation system according to the present invention above described, wherein the opposite flows are each in a form of layer having an oblong cross-section with an aspect ratio (ARₘₐₜᵣᵢₓ) of at least 2:1, preferably at least 3:1, more preferably at least 4:1, even more preferably at least 8:1 at the initial meeting point of the filaments and the impregnating substance.

Preferably, said filaments are subjected to at least two opposite flows of impregnating matrix substance at an angle (β) less than 90°, preferably from 5° to 80°, more preferably from 30° to 60°, with respect to the moving direction of the strand and/or filaments within the passageway.

The supplied impregnating substance may be in liquid form such as a solution, an emulsion, a suspension or a dispersion of said polymer in an aqueous or organic carrier, molten or gel form inside the die at any given impregnating temperature.

Advantageously, the impregnating substance is any matrix or chemical formulation capable of flowing inside the impregnating die. In one preferred embodiment, thermoplastic polymer or their mixtures or blends can be implemented as matrix to be used. Preferably, thermoplastics can be selected from a group of Polyolefins (e.g., PE, PP, PB), Polyamides (e.g., PA, PPA), Polyimides (e.g., PI, PEI), Polyamide-imides, Polysulphones (e.g., PS, PES), Polyesters (e.g., PET, PBT), Polycarbonates, Polyurethanes, Polyketones, (e.g., PK, PEK, PEEK), Polyacrylates, Polystyrenes, Polyvinylchlorides, ABS, PC/ABS and a mixture thereof, or a thermosetting resin precursor can be selected from a group of Epoxy, Ester, Urethanes, Phenolic, Alkyd and a mixture thereof.

The filaments supplied at step (a) are preferably selected from a group of glass fibers, mineral fibers, metallic fibers, carbon and graphite fibers, natural fibers, polymeric and synthetic fibers.

Advantageously, the filaments supplied at step (a) are coated by a sizing and/or binding agent.

The method may further comprise steps of pulling the sandwiched filaments with the impregnating substance through an exit passage having a substantially flat cross-section.

In a second embodiment, the subject matter of the present invention is an impregnation system suitable for impregnating filaments continuously with an impregnating substance, the system comprising an impregnation assembly comprising (a) an inner die comprising a passage space for filaments, a projection end and an entrance end, (b) an outer die comprising an inner space, an exit passage, an exit end and a passage for the impregnating substance, wherein the inner die is positioned in the inner space of outer die and the projection end of the inner die is positioned to form the outlets for the impregnating substance, the filament passageway comprises the passage space of the inner die, the exit passage of the outer die, said passage space and said exit passage being aligned in the axial direction of the filament flow, and (c) at least one adjusting means controlling the distance between the inner die and the outer die along the direction of the axis of the passageway so as to change the size of the outlet for the impregnating substance.

Preferably, the passageway for the filaments has an oblong cross-section with aspect ratio (AR₍₃₀₎) at least 2:1 (w₍₃₀₎:h₍₃₀₎), preferably at least 3:1, more preferably at least 4:1 further preferably at least 8:1, even more preferably at least 20:1, most preferably at least 50:1 at the point of outlet (324) into the filament passageway.

Advantageously, the inner die comprises at least two die units disposed essentially opposite to each other and each die unit is independently adjustable by adjusting means comprised in each die unit.

The impregnation assembly may comprise the at least two outlets for the impregnating substance into the filament passageway essentially opposite to each other at the opposite widths of the filament passageway, said outlets having an oblong cross-section with an aspect ratio (AR₍₃₂₄₎) of at least 2:1 (w₍₃₂₄₎:h₍₃₂₄₎), preferably at least 3:1, more preferably at least 4:1, even more preferably at least 8:1.

In one particular embodiment, the impregnation system further comprises a spreader assembly disposed upstream from the impregnation assembly (3).

According to a further aspect, the present invention consists in a method of producing a reinforced composite structure comprising the steps of (a) supplying two or multiple filaments from one or more sources of continuous filaments, (b) arranging said filaments in a plane, and (c) subjecting said filaments to one or more flows of the impregnating matrix substance and impregnating the filaments within the impregnation system of the present invention according to the second embodiment the method further comprising a step of adjusting the thickness of flow(s) by an adjusting means prior to or during step (c) which is capable to set the distance between the inner die and the outer die along the direction of the axis of the passage.

Preferably, said filaments arranged in a plane are subjected to at least two opposite flows having an oblong cross-section with aspect ratio at least 2:1 at the initial meeting point of the filaments and the impregnating substance.

Advantageously, said filaments are subjected to at least two opposite flows of impregnating matrix substance (8) at an angle (β) less than 90°, preferably from 5° to 80°, more preferably from 30° to 60°, with respect to the moving direction (A) of the strand and/or filaments within a passageway.

The method of the present invention according to both the first and second embodiments preferably comprises further steps of subjecting a strand and/or filaments supplied at step (a) to air flow at an angle, preferably substantially perpendicular, with respect to the moving direction of the strand and/or filaments within the passageway of the spreader assembly.

Advantageously said strand and/or filaments are subjected to the air flow through at least one hole disposed at the one end of a through hole connecting to the passageway, wherein the passageway comprises an inlet opening for receiving said fiber strand and/or filaments, an outlet opening through which said strand and/or filaments exit the passageway, and a divergent zone having an entrance end and an exit end wherein the area of said exit end is larger than the one of the said entrance end.

Preferably, the strand and/or filaments are subjected to the air flow within an inner channel having a rectilinear shape which is disposed between the inlet opening of the passageway and the entrance end of the divergent zone, preferably disposed at a point immediately upstream from the entrance end of the divergent zone.

Advantageously, the method according to the present invention further comprises a step of heating the strand and/or filaments prior to step (c).

The method of the present invention according to both first and second embodiments preferably comprises further steps of flattening the impregnated fibers provided by step (c) and thereafter winding up the impregnated fibers onto a winding core or the steps of shaping the impregnated fibers provided by step (c) collectively into a rod and thereafter cutting the rod to desired length.

According to yet another aspect, the subject matter of the present invention also is a reinforced composite structure obtainable by one of the above-described methods.

In a particular embodiment, the subject matter of the present invention consists in the use of the impregnation system according to the present invention for continuously impregnating filaments with an impregnating substance.

These and other aspects of the present invention will become clear to those of ordinary skill in the art upon the reading and understanding of the specification.

### BRIEF DESCRIPTION OF THE FIGURES

This invention will be further described in connection with the attached drawing figures showing preferred embodiments of the invention including specific parts and arrangements of parts. The drawings included as part of this specification are intended to be illustrative of the preferred embodiments of the invention and should in no way be considered as a limitation on the scope of the invention.

FIG. 1 is a schematic illustration of one preferred embodiment of the impregnation system according to the present invention showing the relationship of various components and apparatus used in the system.

FIG. 2 is a perspective view of a passageway for filaments in an impregnation assembly according to the present invention.

FIG. 3 is a perspective view of the longitudinal cross-section of the impregnation assembly according to the present invention.

FIG. 4 is a cross-section of the impregnation assembly shown in FIG. 3 defined by a cutting plane IV-IV illustrated in FIG. 3.

FIG. 5 is a cross-section of the impregnation assembly shown in FIG. 3 defined by a cutting plane V-V illustrated in FIG. 3.

FIG. 6 is a cross-section of the impregnation assembly shown in FIG. 3 defined by a cutting plane VI-VI illustrated in FIG. 3.

FIG. 7 is a cross-section of another preferred embodiment of the impregnation assembly according to the present invention defined by a cutting plane similar to the one illustrated as IV-IV in FIG. 3.

FIG. 8 is a cross-section of the same impregnation assembly shown in FIG. 7 defined by a cutting plane similar to the one illustrated as V-V in FIG. 3.

FIG. 9 is a perspective view of the longitudinal cross-section of another preferred embodiment of the impregnation assembly according to the present invention.

FIG. 10 is a cross-section of the impregnation assembly shown in FIG. 9 defined by a cutting plane X-X illustrated in FIG. 9.

FIG. 11 is a perspective view of the longitudinal cross-section of the impregnation assembly according to the present invention with a large size of outlet opening for the impregnating substance.

FIG. 12 is a longitudinal cross-section of the impregnation assembly shown in FIG. 11 with a small size of outlet opening for the impregnating substance.

FIG. 12a is a longitudinal cross-section of the impregnation assembly shown in FIG. 11 with a shaping die.

FIG. 13 is a cross-section of the impregnation assembly shown in FIG. 11 defined by a cutting plane XIII-XIII illustrated in FIG. 11.

FIG. 14 is a cross-section of the impregnation assembly shown in FIG. 12 defined by a cutting plane XIV-XIV illustrated in FIG. 12.

FIG. 15 is a perspective view of the longitudinal cross-section of the impregnation assembly shown in FIG. 11 with the inner die removed.

FIG. 16 is a longitudinal cross-section view of another preferable embodiment of the impregnation assembly made in accordance with the principles of the present invention.

FIG. 17 is a longitudinal cross-section scale view of the impregnation assembly shown in FIG. 16 with the inner die removed.

FIG. 18 is a perspective view of the longitudinal cross-section of the impregnation assembly shown in FIG. 17.

FIG. 19 is a side view of the impregnation die assembly shown in FIG. 16 with the outer die removed wherein multi-filaments are being impregnated with the impregnating substance.

FIG. 20 is a top view of the impregnation assembly shown in FIG. 19.

FIG. 21 is a cross-section of the sandwiched multi-filaments with the impregnating substance at initial meeting point of the filaments and the impregnating substance, according to a cutting plane XXI-XXI illustrated in FIG. 19.

FIG. 22 is a cross-section of the impregnated multi-filaments with the impregnating substance, according to a cutting plane XXII-XXII illustrated in FIG. 19.

FIG. 23 is a perspective view of the longitudinal cross-section of another preferred embodiment of the impregnation assembly according to the present invention.

FIG. 24 is a cross-section of the impregnation assembly shown in FIG. 23 defined by a cutting plane XXIV-XXIV illustrated in FIG. 23.

FIG. 25 is a perspective view of the longitudinal cross-section of the impregnation assembly according to the present invention.

FIG. 26 is a cross-section of the impregnation assembly shown in FIG. 25 defined by a cutting plane XXVI-XXVI illustrated in FIG. 25.

FIG. 27 is a side view of a preferable embodiment of the spreader assembly according to the present invention.

FIG. 28 is an elevation view of the outlet opening of the spreader assembly shown in FIG. 27.

FIG. 29 is an elevation view of the inlet opening of the spreader assembly shown in FIG. 27.

FIG. 30 is a plan view of the spreader assembly shown in FIG. 27.

FIG. 31 is a bottom view of the spreader assembly shown in FIG. 27.

FIG. 32 is a longitudinal cross-section scale view of the spreader assembly shown in FIG. 27 according to a cutting plane XXXII-XXXII of FIG. 30.

FIG. 33 is a cross-section of the bottom part of the spreader assembly shown in FIG. 27 according to a cutting plane XXXIII-XXXIII of FIGS. 27 and 28.

FIG. 34 is a bottom view (cross-section) of the top part of the spreader assembly shown in FIG. 27 according to a cutting plane XXXIV-XXXIV of FIGS. 27 and 28.

FIG. 35 is a perspective view of a passageway for filaments in the spreader assembly according to the invention.

FIG. 36 is a cross-section similar to FIG. 33, wherein a bundle of filaments is being spread into individual filaments.

FIG. 37 is an elevation side view of another preferable embodiment of the spreader assembly according to the present invention.

FIG. 38 is an elevation view illustrating the inlets of the spreader assembly shown in FIG. 37.

FIG. 39 is an elevation view illustrating the outlets of the spreader assembly shown in FIG. 37.

FIG. 40 is a plan view of a spreader unit, positioned at the top of the spreader assembly shown in FIG. 37, illustrating four inlets for air.

FIG. 41 is a bottom view of the spreader assembly shown in FIG. 37, illustrating two inlets for air.

FIG. 42 is a bottom view (cross-section) of the top part of the spreader unit shown FIG. 37 according to a cutting plane XLII-XLII of FIGS. 37 to 39.

FIG. 43 is a cross-section of the bottom part of the spreader unit shown in FIG. 37, according to a cutting plane XLIII-XLIII of FIGS. 37 to 39.

FIG. 44 is a plan view of a spreader unit, positioned at the middle of the spreader assembly shown in FIG. 37, illustrating two inlets for air.

FIG. 45 is a bottom view (cross-section) of the top part of the spreader unit shown in FIG. 37 according to a cutting plane XLV-XLV of FIGS. 37 to 39.

FIG. 46 is a cross-section of the bottom part of the spreader unit shown in FIG. 37, according to a cutting plane XLVI-XLVI of FIGS. 37 to 39.

FIG. 47 is a plan view of a spreader unit positioned at the bottom of the spreader assembly shown in FIG. 37.

FIG. 48 is a bottom view (cross-section) of the top part of the spreader unit shown in FIG. 37, according to a cutting plane XLVIII-XLVIII of FIGS. 37 to 39.

FIG. 49 is a cross-section of the bottom part of the spreader unit shown in FIG. 37, according to a cutting plane XLIX-XLIX of FIGS. 37 to 39.

FIG. 50 is a SEM microscope image of a cross-section of a reinforced tape according to the present invention.

FIG. 51 is a SEM microscope image of a cross-section of a reinforced tape according to the present invention.

FIG. 52 is a SEM microscope image of a cross-section of a reinforced tape according to the present invention.

FIG. 53 is a zoomed-in image of the SEM microscope shown in FIG. 53.

FIG. 54 is a SEM microscope image of a cross-section of a reinforced tape impregnated within an impregnation assembly having only one outlet for impregnation substance.

### DETAILED DESCRIPTION OF THE INVENTION

The present invention seeks to overcome several of the problems experienced with the prior art means and processes for producing continuous filament reinforced composite products.

Such problems include more specifically poor wetting or impregnation of the continuous filaments and slow operation speeds or friction and fuzz creation. The present invention seeks to overcome these problems by feeding the fibers to be impregnated through a specially designed impregnation die assembly. The general design of the die assembly allows for the maximization of the contact between the impregnating matrix and the filaments of a multifilament strand. The present invention also enables operation at much reduced friction thereby avoiding or at least substantially reducing fuzz creation and improving the line speeds and hence the productivity. The present invention also provides an advantageous die which allows to omit a further degassing system. The present invention also provides the manufacturer with the flexibility to use any suitable raw material, color and additive package as well as to adjust the fiber content of the composite structure. The present invention also overcomes the environmental and emission problems linked to the emission of hazardous, volatile chemicals and solvents by impregnating the fibers in a closed impregnation system. The present invention also solves the problem of uniformly distributing the reinforcing continuous fibers in a composite structure by feeding the spread fibers in a converged way in a flat shape arrangement, sandwiching them between two portions of impregnating substance, and then pulling them through a passage having a flat cross-section. The present invention further solves the problem of achieving an optimum fiber to polymer ratio by adjusting the amount of impregnating substance sandwiching the fibers at the initial meeting point of the fibers and the impregnating substance even during operation. It offers a flexible operation for responding to various requests raised during operation.

“Filament” or “monofilament” as used herein is intended to mean& the smallest increment of fiber. The terms “strand”, “tow” or “bundle” as used herein, is intended to mean a plurality of individual fibers ranging from, but not limited to, dozens to thousands in number, collected, compacted, compressed or bound together by means known to the skilled person in order to maximize the content thereof or to facilitate the manufacturing, handling, transportation, storage or further processing thereof. “Tape” is typically a material constructed of interlaced or unidirectional filament, strands, tows, or yarns, etc., usually pre-impregnated with resin.

The continuous fibers that may be employed in accordance with the present invention to reinforce a matrix such as thermoplastic or thermosetting resin are either organic, synthetic, natural, mineral, glass, ceramic, metallic or mixture of them and contain a plurality of continuous filaments. The fibers may be in any form and combination, such as filaments, strands, non-woven veil, continuous filament mat, chopped strand mat, fabric, strong enough and having sufficient integrity and strength to be pulled through the impregnating substance such as molten thermoplastic polymer, and that may conveniently consist of bundles of individual filaments, referred to in the art as “strand”, in which substantially all of the filaments are aligned along the length of the bundles. Preferably, the fibers are in a strand form, made up of continuous filaments. Any number of such strands may be employed. Suitable materials include strands and tapes of glass fiber, mineral, ceramic, metallic, carbon, graphite fiber, synthetic, polymeric fibers or natural fibers or mixtures and blends of them. In the case of commercially available glass rovings, each strand may consist of one or several smaller strands with altogether up to about 6,000 or more continuous glass filaments. Carbon fiber containing up to about 50,000 or more filaments may be used. Synthetic fibers that may be utilized within the scope of the present invention include polyolefin, aramid fibers, polyester, polyamide, polyimide fibers, acrylic fibers, vinyl fibers, benzoxazole based fibers, cellulose and cellulose derivative based fibers, carbon, graphite fibers, polyphenylene sulfide fibers, ceramic fibers. Continuous fibers may be provided with any of the conventional surface sizing, particularly those designed to facilitate storage and transport before processing and improve usability. Additionally, other coatings may be included on the fibers, particularly glass fibers, in order to protect the fiber from abrasion and improve the characteristics of the final composite part.

In the present invention, the impregnation substance may be a thermoplastic or a thermosetting precursor system, preferably crystalline or semicrystalline engineering thermoplastics that are commonly reinforced with fibers in the composite industry. Examples of the thermoplastic polymers include broad categories of polyolefins, polyamides, polycarbonates, polystyrenes, polyesters, polyvinyl chlorides, polyketones, polyetherketones, polyetheretherketones, polysulfides, polysulfones, polacetals, ABS or any combination thereof. One particularly preferred material includes polypropylene. Suitable thermosetting polymer precursors are for example, those based on Epoxy, Novolak, Phenolics, Polyesters, vinylester resin, Polyurethanes. The impregnating substance may be in liquid form such as solution, emulsion, suspension and dispersion of said polymer in an aqueous or organic carrier, in molten form or in gel form inside the die at any given impregnating temperature. The viscosity of the impregnating substance such as thermoplastic matrix in the impregnation die assembly can be adjusted by controlling the temperature of the die assembly, up to just below the degradation temperatures of the impregnating substance, in order to have the optimum melt viscosity for the impregnation. Various additives may be added to the impregnating substance, in accordance with the processing and end use of the composite structure reinforced with long fibers, and conditions under which the composite structure is used. Such additives include antioxidants, mold releasing agents, impregnation accelerators, fire retardants, impact modifiers, viscosity reducers, lubricants, compatibilizers, coupling agents, wetting and leveling agents and colorants.

The process and impregnation assembly are described in greater detail with reference to the drawings below.

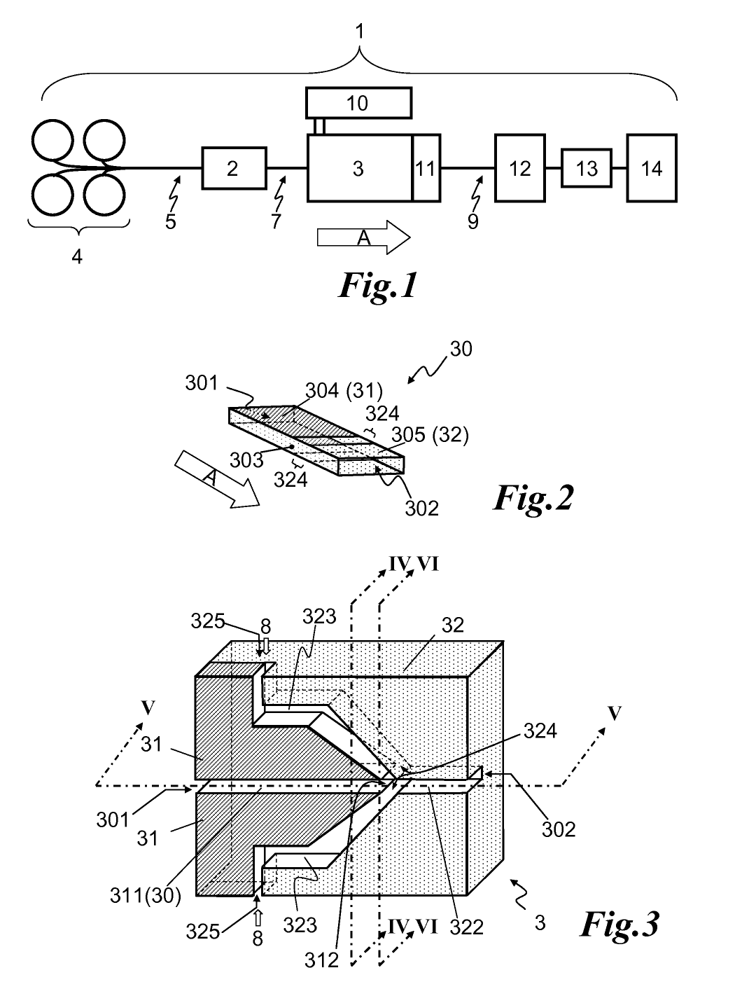

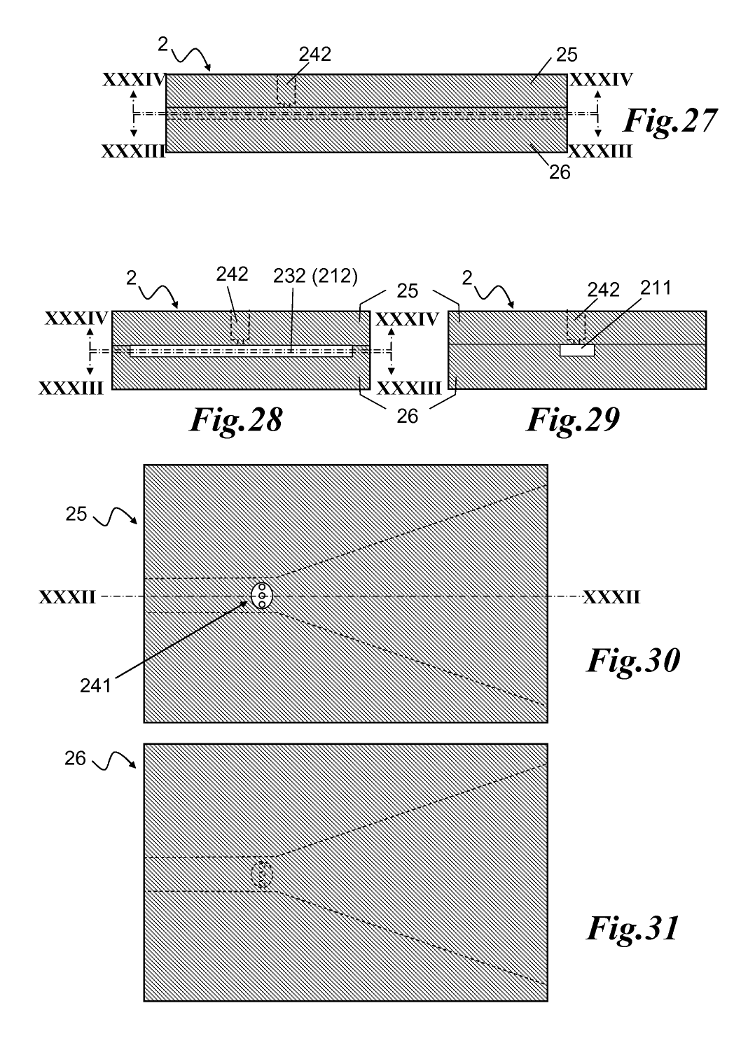

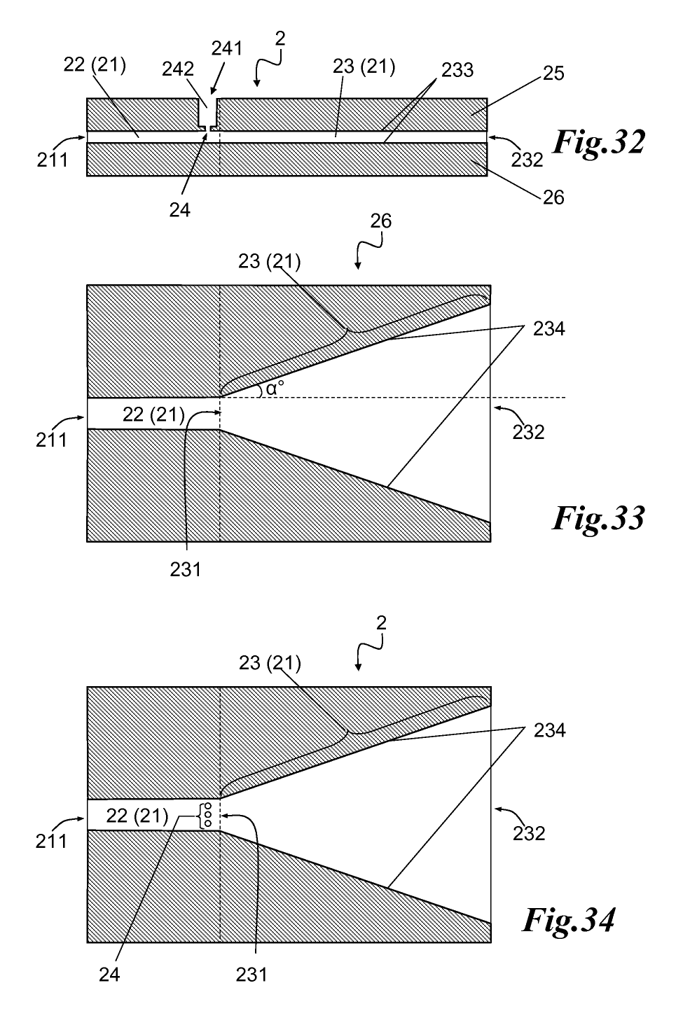

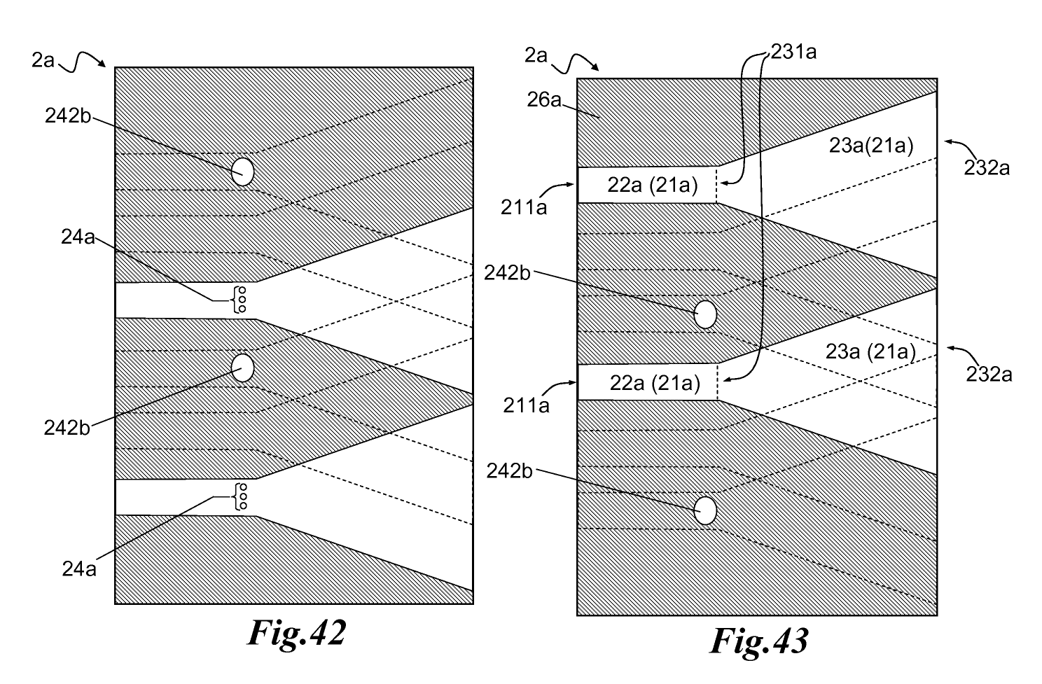

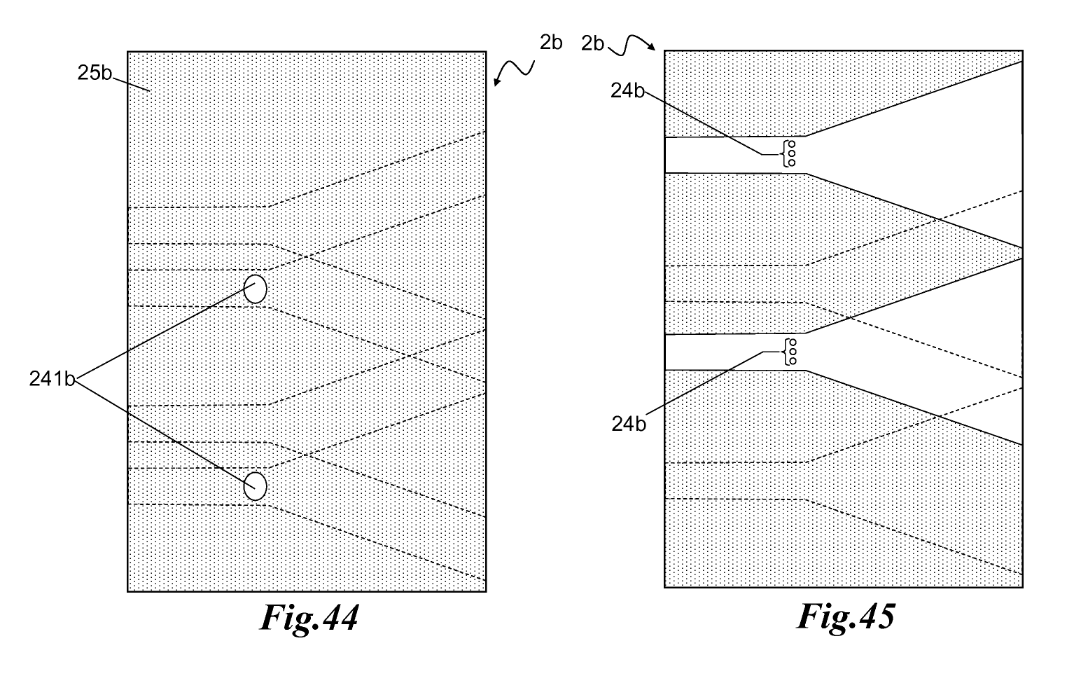

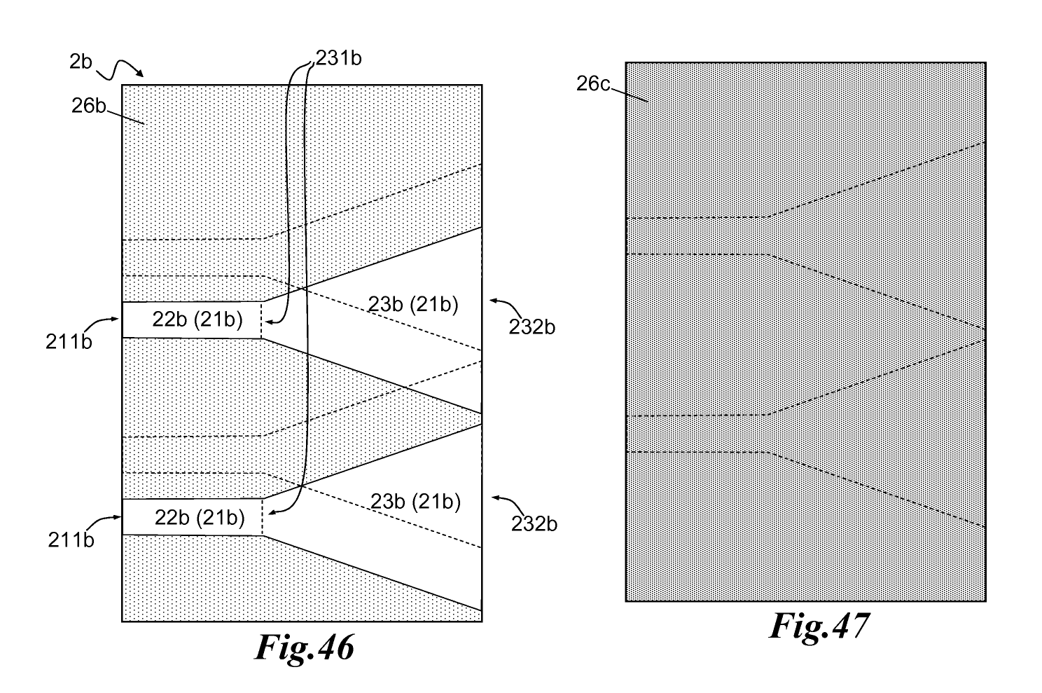

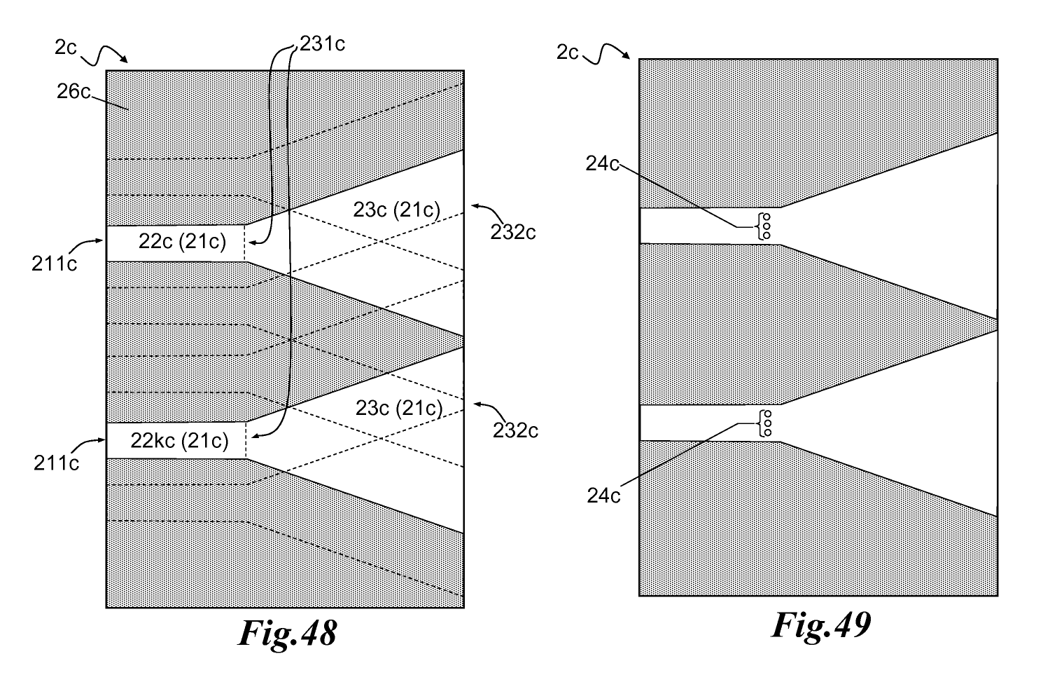

FIG. 1 shows schematically the various pieces of equipment and apparatus useful to carry out the process according to the illustrated embodiment of the invention. A bundle of continuous fibers 5 is supplied from a source 4 of continuous filament. The bundle of continuous fibers 5 is preferably twist-free, also known in the art as strand or roving. The fibers go through an opening and spreading means 2. Although an air blowing means 2 is described in FIGS. 27 to 49, any other strand opening and spreading means may be used. The resulting fiber-opened/spread bundle 7 is fed through the impregnation die assembly 3. An impregnating substance 8 is delivered preferably under pressure to the impregnation assembly 3 utilizing e.g. an extruder 10 or a pump system. The resulting impregnated fibers 9 may be given a desired shape with a shaping die 11 (profile die) such as a roving, rod, ribbon, tape, plate, panel, tube, cylinder or any other special shape. The continuous fibers 9 impregnated with the impregnating substance 8 are taken up with a conventional pulling mechanism 13 after passing through the shaping die 11 (profile die). Using a squeezer die (profile die) or squeezing rolls or a doctor blade or the like, the polymer content and hence the fiber content of the composite material can also be optimally adjusted. Fiber contents from 10 to 80% by weight of the total, preferably from 20 to 70%, and most preferably from 30 to 65%, are desired. The composite structure reinforced with long fibers which have been taken-up with a pulling mechanism 13 may be allowed to be cooled naturally or by a cooling means 12, or may be consolidated or cured with heating elements or a heating die (not illustrated) if required. Depending upon the need, the hot impregnated continuous fiber exiting the die assembly may be directly wound with 14 on a winding core to make a final composite part or shaped into different profiles and then cut optionally to a desired length with a cutter or pelletizer prior to further processing. Thus, direct winding of impregnated fibers results in an in-line impregnated continuous fiber reinforced composite structure, whereas after shaping and cutting the impregnated fibers, the obtained fiber reinforced composite structure comprises well impregnated reinforcing fibers which have substantially the same length as the composite structure and which are aligned in parallel to the longitudinal direction of the composite structure and uniformly dispersed therein.

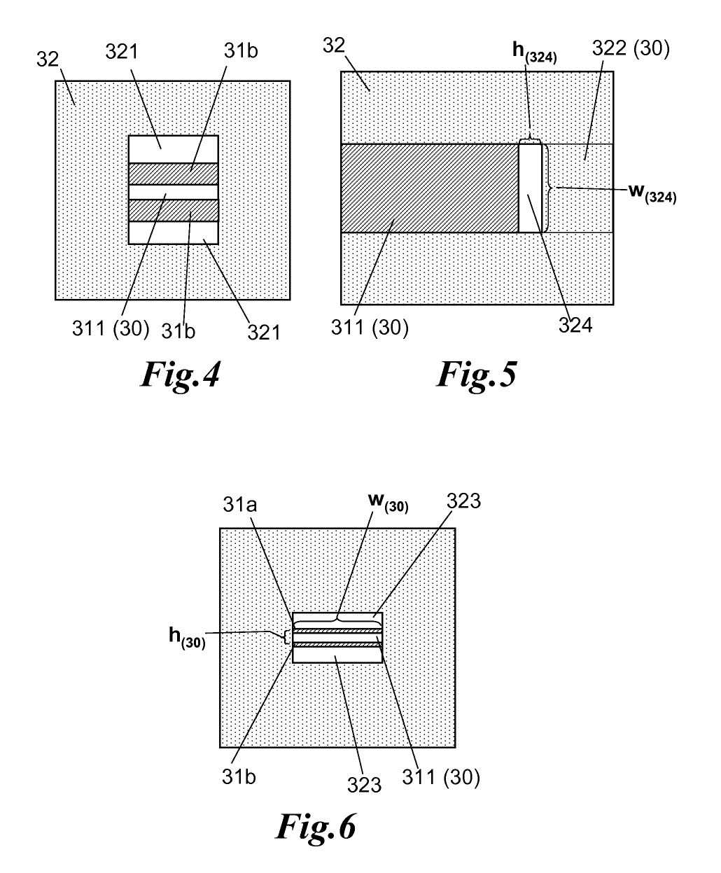

Referring now to FIGS. 2 to 6, a specific structure of the impregnation assembly 3 is described in more details. Specifically, impregnation assembly 3 comprises a passageway 30 for filaments having an entrance end 301 and an exit end 302 and two passageways 323 for the impregnating substance having each an inlet 325 and an outlet 324. The impregnating substance flows from the passageway 323 into the passageway 30 for filaments via the outlets 324 and enter into contact with the filaments. These outlets 324 are at the initial meeting point of the filament and the impregnating substance. The passageway 30 for filaments has a oblong cross-section, preferably substantially rectangular cross-section at the initial meeting point. The aspect ratio of said cross-section of passageway 30 is represented as AR₍₃₀₎ in FIG. 6 which is the ratio of its width, w₍₃₀₎, to its height, h₍₃₀₎, i.e., AR₍₃₀₎=w₍₃₀₎:h₍₃₀₎. The aspect ratio AR₍₃₀₎ at the initial meeting point is at least 2:1, preferably at least 4:1, more preferably at least 8:1, even more preferably at least 20:1, most preferably at least 50:1, in order to obtain a better impregnation. The intersections of the two outlets 324 for the impregnating substance with the passageway 30 also advantageously have an oblong shape and are located across the passageway 30, opposed to each other. The aspect ratio of the intersections are represented as AR₍₃₂₄₎ in FIG. 5 which is the ratio of its width, w₍₃₂₄₎, to its height, h₍₃₂₄₎, i.e., AR₍₃₂₄₎=w₍₃₂₄₎:h₍₃₂₄₎.

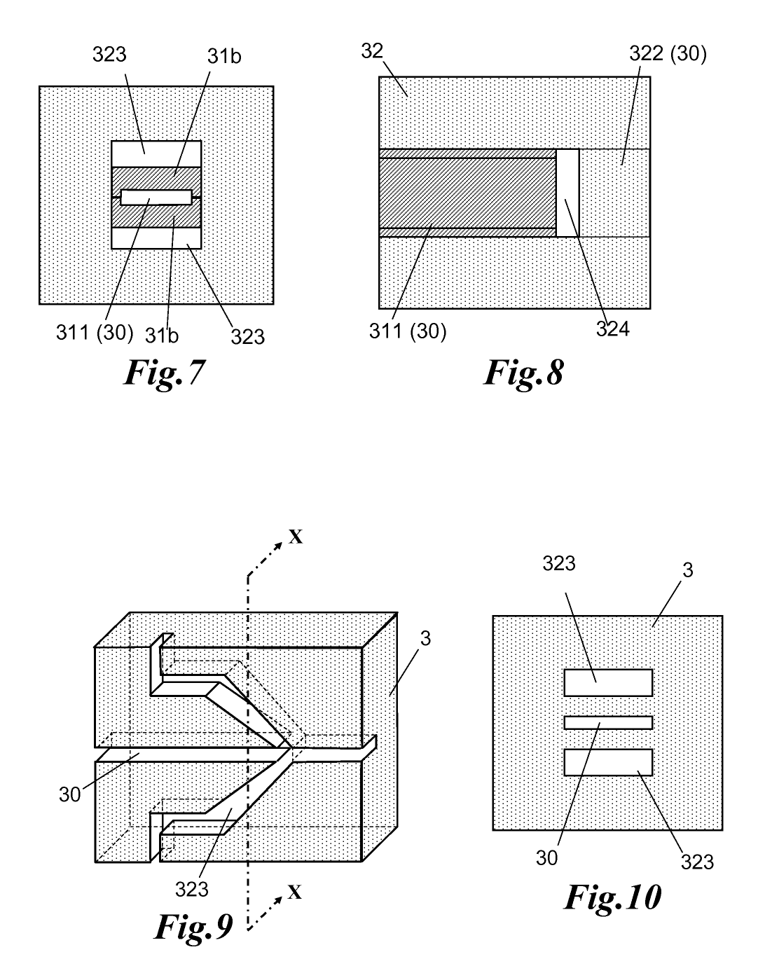

In a first embodiment described in FIGS. 3 to 6, the impregnation assembly 3 is composed of an inner die 31 and an outer die 32. The inner die 31 defines a passage space 311 having an entrance end 301 and a projection end 312 which forms part of the passageway 30. The outer die 32 comprises an inner space 321, an exit passage 322 which forms part of the passageway 30, two passages 323 for the impregnating substance, two inlets 325, and two outlets 324 whose shape is defined by positioning the inner die 31 with respect to the inner space 321 of the outer die 32. The width of the passage space 311 may be essentially the same as the one of the passageway as shown in FIGS. 5 and 6 or smaller than the one of the passageway 30 as shown in FIGS. 7 and 8. The projection end 312 of the inner die 31 has a flat cross-section, preferably rectangular cross-section. The projection end 312 is positioned inside of the inner space 321 of the outer die 32 to make the two outlets 324 for the impregnating substance having an oblong shape and being located opposite to each other and across the passage 30. In the passageway 30 of the impregnation assembly 3, the passage space 311 and the exit passage 322 are aligned and a wall 304, immediately upstream of the outlet 324, consists of a part of inner die 31, and a wall 305, immediately downstream of the outlet 324, consists of a part of an outer die 32 as shown FIG. 2. An impregnation assembly may be provided with a die instead of the combination of an inner die and an outer die by making grooves thereon as a passageway (30) for filaments and a passageway (323) for impregnating substance as shown in FIGS. 9 and 10.

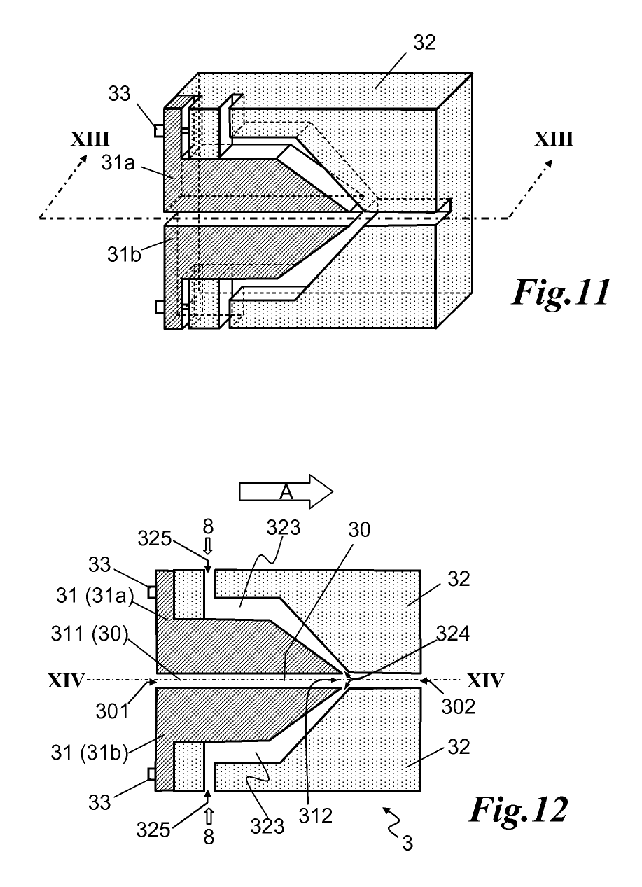

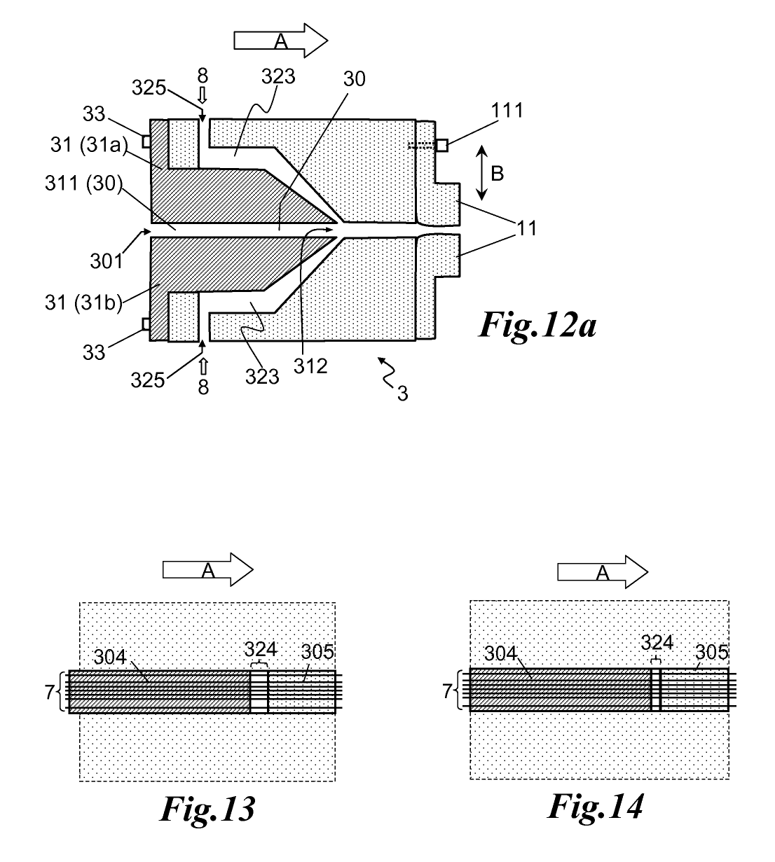

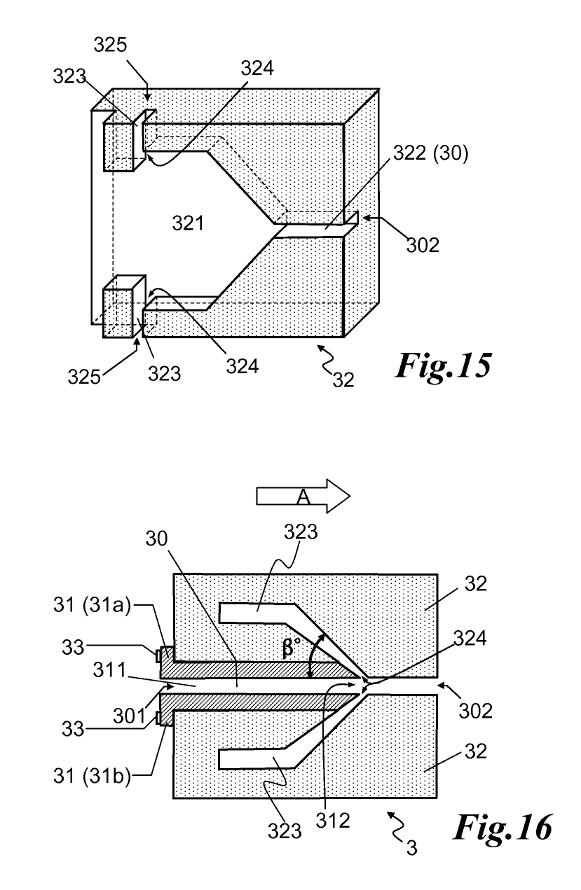

In a preferred embodiment shown in FIGS. 11 to 14, the impregnation assembly 3 further comprises one or more adjusting means 33. The adjusting means adjustably move the wall 304 immediately upstream of the outlet 324 in to-and-fro motions with respect to the outlet 324 so as to change the size or the area of the outlet 324. FIG. 14 shows a cross-section of the impregnation assembly with a small size of the outlet 324 of the passage 30 defined by a cutting plane XIV-XIV illustrated in FIG. 11, and FIG. 13 shows a cross-section of the impregnation assembly with a large size of the outlet 324 of the passage 30 defined by a cutting plane XIII-XIII illustrated in FIG. 12. The inner die 31 may be separated into two pieces 31a and 31b, for example an upper section and a lower section, and each section may be capable of moving individually along the axis of the passageway 30. The inner die 31 is attached to the outer die via flanges protruding from the inner die 31 using any one of a variety of devices such as a screw. The position of the inner die 31 is horizontally adjustable along the axial passageway 30 by tightening or turning a screw 33 which attaches the inner die 31 to the outer die 32, as shown in FIG. 12. The adjusting means may also be pneumatic and/or hydraulic adjusting means. This adjustment may be operated during processing, either manually and/or automatically, while the operator receives and analyses feedback on the impregnated composite's properties.

The impregnation die may further comprise a shaping die 11 placed immediately downstream of the exit passage 302 of outer die 32. The shaping die may comprise at least two die units disposed essentially opposite to each other, and at least one die unit may be slidably adjustable in an up or down movement by the corresponding adjusting means comprised therein along the arrow B shown in the FIG. 12a. Said adjusting means 111 of the shaping die 11 may comprise an eccentric screw to adjust the distance between the opposite shaping die units. The advantage of such a system is the possibility to manipulate the outcome during the running of the line or production just by turning the screw.

In order to ensure a sufficient flow rate of the impregnating substance, especially thermoplastic matrix, in the impregnation assembly 3, the impregnation assembly 3 is preferably heated with a heater placed along the outer die 32 and maintained at a temperature range usually suitably above the melt or softening temperature of the thermoplastic resin. The thermoplastic melt is fed into the die at a pressure of preferably from 1 to 80 bars, more preferably from 10 to 60 bars and most preferably from 15 to 50 bars.

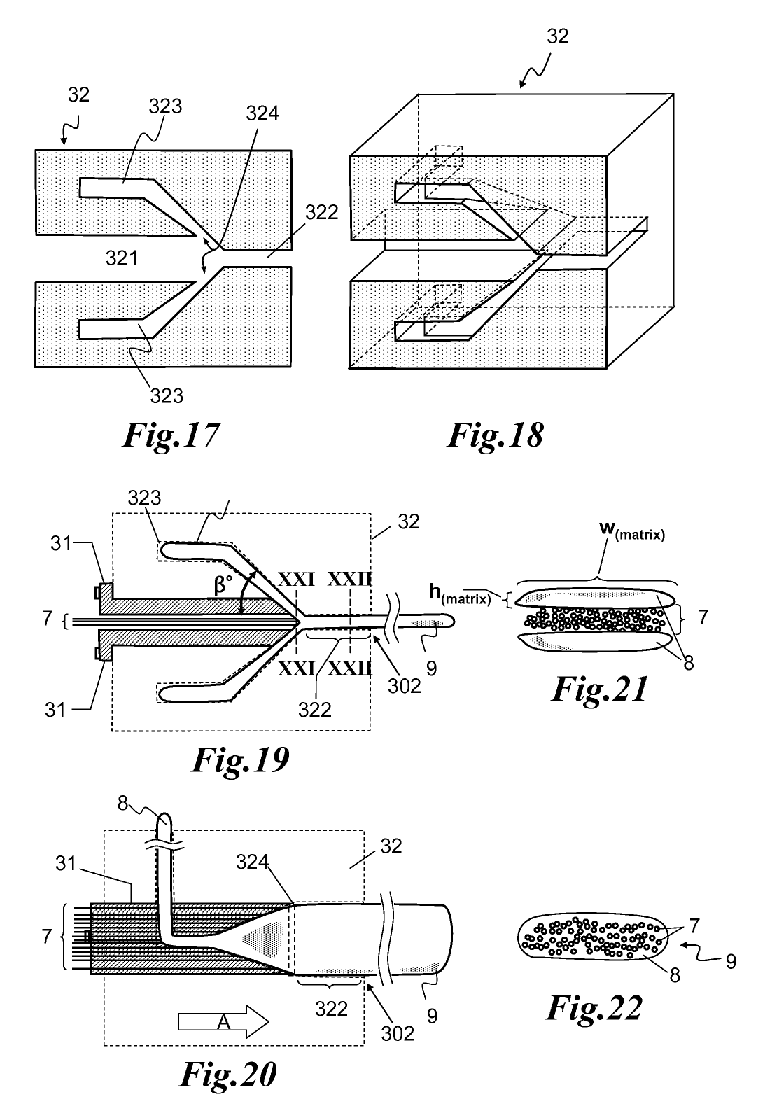

FIGS. 16 to 18 show another preferred embodiment of the impregnation assembly 3. A passage 323 for the impregnating substance may require only one inlet (not illustrated) and bifurcate into two passages continuing to at least two outlets 324. As shown in FIG. 18, the impregnating substance may be provided to the passage 30 of the impregnation assembly 3 through a channel having rectilinear shape and then pass through a divergent zone having a flat cross-section at the exit end thereof. The size of the outlet 324 is adjustable by sliding the inner die 31 relative to the outer die 32 using for instance screws 33 which set the distance between the inner die 31 and the outer die 32 along the axial direction of the passage 30 of the impregnation assembly. The injection angle (β°) of the impregnating substance into the passageway 30 defined by the divergent zone of the passage 323 may be less than 90° with respect to the direction (A) of filaments, preferably from 5° to 80°, more preferably from 30 to 60°, so as to facilitate feeding filaments ahead and assist the impregnation process, while avoiding breakage of filaments. The combination of this injection angle and the injection pressure provided by the two opposite layers of the impregnating matrix allow for upstream escape of the air trapped within a bundle of filaments arranged in a plane and result& in the good impregnation under high operation speed.

FIGS. 19 and 20 illustrate schematically a preferred process for the impregnation using the impregnation assembly 3. The impregnating substance 8 is provided through the passage 323 of the outer die 32 illustrated in FIGS. 16 to 18 via the two outlets 324 to the passageway 30 of the impregnation assembly 3 and meets the bundle of fibers 7 passing through the passageway 30. The bundle of fibers 7 in this context is a number of filaments which are spread substantially individually with a spreader shown in FIGS. 27 to 49 or other conventional fiber-opening or spreading means prior to entering the impregnation assembly 3. In the passage 30 having a flat cross-section with an aspect ratio (AR₍₃₀₎=w₍₃₀₎:h₍₃₀₎) of at least 2:1, preferably at least 4:1, more preferably at least 8:1, even more preferably at least 20:1, most preferably at least 50:1, the opened or separated fibers are arranged in a plane. The outlets 324 have oblong or rectangular shapes with the aspect ratio (AR₍₃₂₄₎=w₍₃₂₄₎:h₍₃₂₄) of at least 2:1, more preferably at least 3:1, even more preferably at least 4:1, most preferably at least 8:1 and are located opposite to each other. The spread bundle of fibers 7 meets the two flows of impregnating substance 8 introduced to the passageway 30 via the outlets 324 at an angle (β) of less than 90°, preferably from 5° to 80°, more preferably from 30° to 60°, with respect to the moving direction (A) of the filaments. The two flows of impregnating substance 8 having an oblong cross-section with an aspect ratio (AR₍ₘₐₜᵣᵢₓ₎=w₍ₘₐₜᵣᵢₓ₎:h₍ₘₐₜᵣᵢₓ) of at least 2:1, more preferably at least 3:1, even more preferably at least 4:1, most preferably at least 8:1, sandwich the filaments and pass through the exit passage 322 of the outer die 32 while impregnating into the filaments, and then exit the impregnation assembly 3 via the exit end 302 as a unitary impregnated fiber-reinforced composite product 9.

The impregnation assembly 3 may be constructed of any one of a variety of materials used for die tooling, such as tool steels, carbon steels, and stainless steels. Preferably, the impregnation assembly 3 construction is based on suitable stainless steel material.

It is significant that the design of the impregnation assembly 3 in accordance with the present invention allows for the spread or separated fibers to be pulled with much reduced friction through the impregnation die 3, and therefore, at a relatively high rate (e.g. exceeding 1 m/sec) in order to give higher output and productivity. It is to be noted that the impregnation assembly to impregnate the spread fibers does not impose speed limitations on its own. The limitations rather come from the product to be made in-line after the impregnation of the fibers or from post-treatments of the impregnated fibers or from the capacity of the impregnating material feeder (e.g. extruder or a pump). The running speeds need to be practical which will depend upon the composite structure to be made with its requirements.

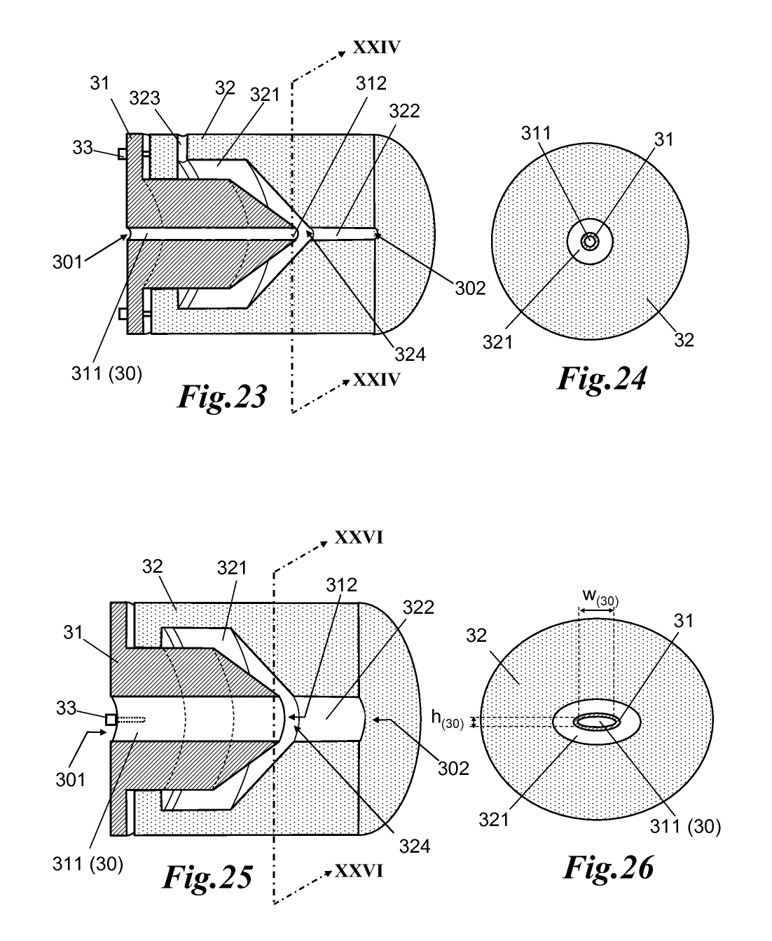

In another embodiment shown in FIGS. 23 to 24, the impregnation assembly 3 is composed of (a) an inner die 31 comprising, a passage space 311 for filaments, a projection end 312 and an entrance end 301, (b) an outer die 32 comprising an inner space 321, an exit passage 322, an exit end 302 and a passage 323 for the impregnating substance. Said inner die 31 is positioned in the inner space 321 of outer die 32 and the projection end 312 of the inner die 31 is positioned to form the outlets 324 for the impregnating substance. Said passageway 30 comprises the passage space 311 of inner die 31, the exit passage 322 of outer die 32 and said passage space 311 and said exit passage 322 are aligned. The impregnation assembly 3 further comprises at least one adjusting means 33 controlling the distance between inner die 31 and outer die 32 along the direction of the axis of the passageway 30 so as to change the size of the outlet 324 for the impregnating substance. The passageway 30 for the filaments preferably has an oblong cross-section with an aspect ratio (AR₍₃₀₎) of at least 2:1 (w₍₃₀₎:h₍₃₀₎), preferably at least 3:1, more preferably at least 4:1 at the point of outlet 324 into the passageway 30 as shown in FIGS. 25 and 26. The adjusting means may be pneumatic and/or hydraulic adjusting means. This adjustment may be made during operation manually and/or automatically while receiving and analysing feedback on the impregnated composite's properties.

As a preferable application of the present invention, the impregnation assembly and the method of the invention may be used for an in-line manufacture of a filament-wound product, such as wound vessel or wrapped tube, by winding the continuous long fibers onto a winding core, of various shapes and sizes, after the impregnation step. Advantageously, the winding step can be carried out immediately after the impregnation step, when the impregnated fibers are still hot so that a consolidation step is reduced or discarded.

A method for manufacturing a tube structure by helically winding up a band material of thermoplastics reinforced with short fibers onto a winding core in an overlapping manner are known, for example, from CA 2548983. In this method, before the reinforced thermoplastic material in a tape-shape is wound onto a mandrel, the cut fibers are mixed with the thermoplastic material.

Contrarily, according to the preferable method, the impregnating substance in a tape-shape, such as thermoplastic tape, is reinforced with continuous long fibers and wound up onto a winding core. After the continuous fibers impregnated with the impregnating substance have emerged from the impregnation assembly, they may be wound onto a winding core in an overlapping manner.

The winding core may be coupled to a motor so as to rotate and practice as pulling mechanism 13 which pulls the fibers supplied from the source 4 of continuous fibers 5 through the impregnation assembly 3 as shown in FIG. 1.

The winding core may be mounted on a complex robotic rotation equipment or simpler reciprocating mechanism that is adapted to be displaced to and fro along a guide parallel to the winding core. The continuous fibers impregnated with the impregnating substance may be supplied to the winding core from the impregnation assembly via a profile die, preferably, under an oblique angle.

The winding core may be surrounded by means for controlling the temperature in order to keep the impregnating substance in a softened state.

The wound vessel or wrapped tube manufactured according to the preferred method of the present invention may have distinguished mechanical properties and aesthetic aspect caused by the fibers exiting in continuous state and in parallel within the wrapping tape of the impregnating substance.

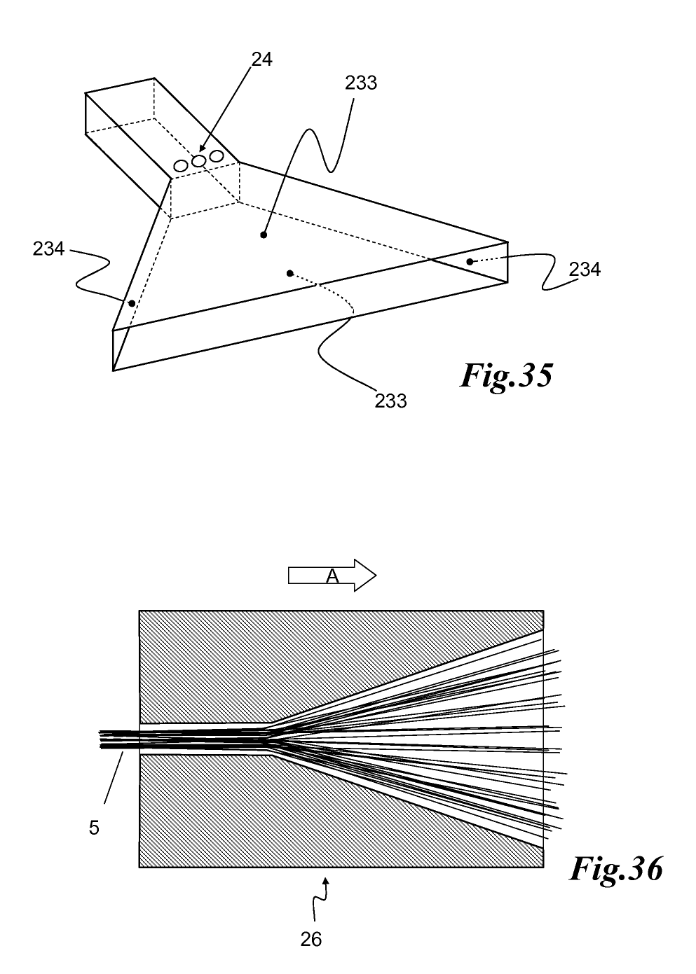

FIGS. 27 to 35 illustrate a preferred embodiment of a spreader assembly 2 according to the present invention. As shown in FIGS. 27 to 29, and 32, the spreader assembly 2 is provided with a cover 25 and a base 26 to be joined together so that a passageway 21 for the fibers is provided as illustrated in FIG. 35. The spreader assembly comprises two side surfaces, a back surface, a front surface, a top surface and a bottom surface. The cover 25 is a rectangular plate having a certain thickness and comprises a through hole 242 passing through the thickness of the cover 25 as best shown in FIG. 32. The through hole 242 allows for passage of air. One of the end of the through hole 242 corresponds to a air inlet 241 as shown in FIG. 30, which is disposed on the top surface 204 of the cover 25. The opposite end of the through hole 242 corresponds to an air outlet 24 having three small holes as shown in FIGS. 32 and 34. The bottom surface of the cover 25 forms a top wall for the passageway 21 (FIGS. 27 to 29, 32 and 35). The base 26 is a rectangular plate having a certain thickness and comprises a groove 21 in axial longitudinal direction, which corresponds to the passageway 21 for the fibers. The groove 21 comprises a rectilinear zone 22 and a divergent zone 23. The rectilinear zone 22 has a constant width and depth from the one side of the base 26 to the point 231, which is the inter connection of the rectilinear zone 22 and the divergent zone 23 as shown FIGS. 32, 33 and 35. The divergent zone 23 has preferably a constant depth but may be varied over its length in order to get the best spread for the fibers. The zone 23 comprises sidewalls 234, which diverge outwardly at an angle α° from the point 231 to an exit end 232 on the back surfaces of the base 26 as shown FIGS. 32, 33 and 35. The cover 25 and the base 26 are joined together by convenient joining means, such as screws or clamps (not shown). The groove 21 of the base 26 and the bottom surface of the cover 25 form a passageway 21 for filaments as shown in FIGS. 32, 34 and 35. The passageway 21 has an inlet opening 211, an outlet opening 232, a divergent zone 23 provided by the divergent zone 23 of the base 26 and the cover 25, and an inner channel 22 provided by the rectilinear zone 22 of the base 26 and the cover 25. The air outlet 24 is preferably positioned so as to be within the inner channel 22 and immediately upstream from the divergent zone 23 so that the compressed air, applied to the fiber strand, breaks up links between the individual filaments without wasting the air. In case that the assembly does not comprise the rectilinear inner channel 22, the air outlet 24 may be adjacent to the entrance end 231 of the divergent zone 23. The small holes disposed in the air outlet 24 may be one or more than one and the number of holes may be varied as per input strand width and the requirement to achieve optimum opening of this strand into either smaller strands or individual fibers. The small holes may be aligned along a transversal direction of the inner channel 22. As illustrated, through hole 242 corresponding to a passageway for air passes through the cover 25 at an angle, preferably substantially perpendicular with respect to the passage 21 for filaments. Alternatively, it is possible to orient the through hole 242 to practically desired angle to achieve the best separation. The diverging angle α° of sidewall 234 of the divergent zone 23 is from 5° to 45° preferably 10° and 40°. It is to be mentioned, that the angle α° is selected in such way as to achieve the desired width for the spread fibers, which will depend upon the width requirement for subsequent processing. If wider spread is required, larger angles and/or longer divergent zones will need to be selected. The length of the inner channel 22 is preferably, but not limited to, between 10 and 30 mm. The width (w₍₂₂₎) and the height (h₍₂₂₎) of a cross-section of the inner channel 22 is selected as per input fiber strand width as well as thickness so that the input fiber strand passes preferably easily through the channel 22, allowing efficient use of air for separating the strand into individual fibers. The inner channel 22 has a rectangular cross-section with the aspect ratio (AR₍₂₂₎=w₍₂₂₎:h₍₂₂₎) at least 2:1, preferably at least 3:1, more preferably at least 4:1, and even more preferably at least 12:1. The passageway 21 for filament may comprise only a divergent zone 23 without any rectilinear channel. The equipment advantageously enables other purposes, for example, if only breaking open the links, present between the fibers within a tightly bound strand, is desired, then choosing the smallest possible α°, preferably less than 2°, will provide such a result. The depth of the divergent zone 23 may be gradually varied. The width and the length of the divergent zone 23 may also be suitably altered to obtain desired dimensions or desired cross-section area for the spread fiber. FIG. 36 shows as an example a opening and spreading process of a fiber strand within a passageway 21 comprising a divergent zone 23 having sidewalls 234 that diverge at an angle α° from the inner channel walls as the fiber strand moves in the direction represented with the arrow A and where the compressed air is applied perpendicularly to the fiber strand at a point immediately upstream from the divergent zone. The arrow represents the principal moving direction of the fibers.

A fiber strand may be supplied from a fiber strand source, such as commercial available spool or roving. The fiber strand is passing into the passageway 21 across the spread assembly 2 through an inlet opening 211. The fiber strand can move or pass freely through the rectilinear 22 and diverging 23 channels. The passing fiber strand attains the velocity according to the pulling force applied by the in-line subsequent process or by any suitable means. No special or separate pulling device is needed, in the case where the subsequent process is pulling the fibers. For example, a motorized rotating cylinder, tube or a mandrell can pull the fibers during winding process at a given winding speed. Also in another example, the impregnated fibers may be shaped into a rod and be pulled by a chopper to make pellets of desired length. As it is understood, the speed will be determined by the speed requirement of the subsequent process such as pelletization. For example, the pelletization may be run at a speed of dozens to hundreds meter/min.

Compressed air flow supplied to the air passage through the air inlet 241 is applied to the fiber strand 5 at an angle, preferably perpendicularly, within the passage through small holes disposed at the air outlet 24. The air pressure is selected depending upon the strength of the links between individual fibers. The preferred pressure of air flow entering into the spreader assembly 2 is in the range of approximately 0.1 to 5 bars. For a commonly available commercial strand, air pressures of 0.5 to 3 bars may very well be suited to get good opening of fibers. A pressure gradient is created across the divergent zone 23. Due to the pressure differential, the air entering the divergent zone 23 through its entrance end 231 flows through the entire width of the divergent zone 23 toward the outlet end 232 thereof. Accordingly, at first, the perpendicular air flow breaks up the links between individual filaments in the bundled fiber strand 5 created by, for example, a sizing or binding agent, physico-chemical interactions, electrostatic force, mechanical, compaction or friction forces, and then, the divergent air stream created in the divergent zone forces the loosened and separated strands or filaments to spread widely and to disperse uniformly as shown in FIG. 36. An advantage of the invention is that it may be practiced simultaneously upon two or more fiber strands that are spread widely and dispersed uniformly by using a spreader assembly comprising two or more spreader units or passageways for filaments disposed one above the other or side by side. It is suitable for manufacturing a composite structure comprising a large amount of reinforcing fiber as well as wide composite bands. Thus, several separate spreader units or channels may be combined together and placed in such a combination as to obtain desired width for the spread fibers and desired amount of glass % by weight required for the in-line subsequent processing into a composite reinforced structure. Furthermore, by connecting each inlet for air of the spreader units or channels to an air compressor by conventional means, all spreader units or channels may share one air supply.

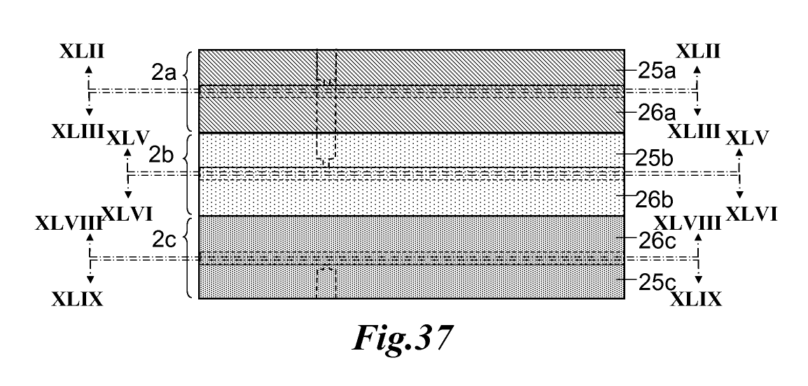

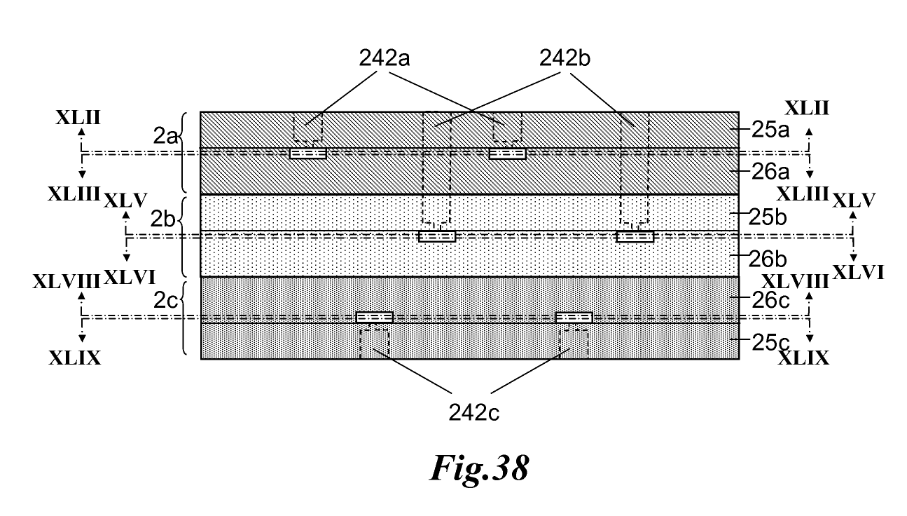

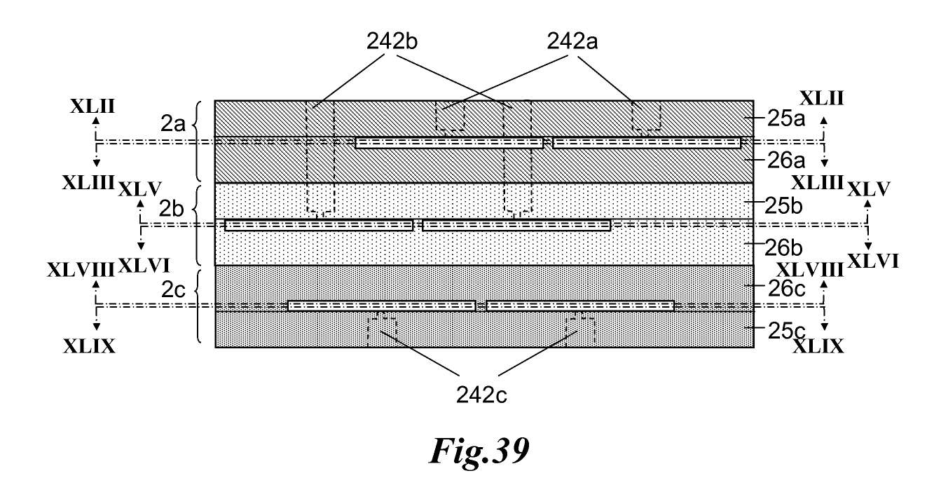

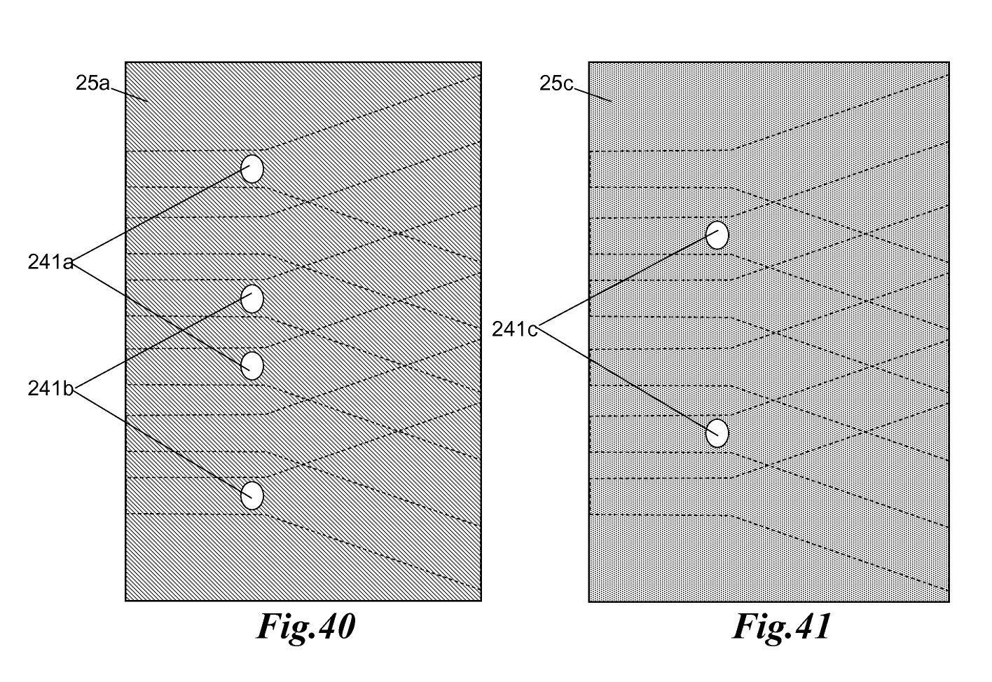

According to other embodiments more than one spreader unit having more than one passageway for filaments can be stacked. FIGS. 37 to 49 illustrate another preferred embodiment of the spreader assembly 2 according to the present invention comprising three spreader unit, 2a, 2b and 2c, and six passageways for filament, 21a, 21b, 21c. Each spreader unit, 2a, 2b and 2c, comprises a cover, 25a, 25b and 25c, and a base, 26a, 26b and 26c, which are joined together by a conventional means such as screws or clamps. Each unit, 2a, 2b and 2c, comprises a pair of passageways for filaments, 21a, 21b and 21c, placed in parallel to each other. The pairs of passageways 21a and 21b of units 2a and 2b are shifted in a lateral direction in order to avoid overlapping of the position of the through holes 242a of unit 2a with the one 242b of unit 2b. The pair of passageway 21c of the unit 2c is positioned in the middle of the unit 2c. The cover 25a of the spreader unit 2a comprises four through holes 242a and 242b corresponding to air passages as shown in FIGS. 38, 39 and 42 to 44. The two through holes 242a are connected to the passageways 21a via the air outlet 24a relatively and the other through holes 242b are connected to the passageways 21b via the through holes 242b relatively. The holes 242b pass through the cover 25a, the base 26b and the cover 25b. The cover 25c of the spreader unit 2c comprises two through holes 242c corresponding to air passages as shown in FIGS. 38 and 39. The through holes 242c are connected to the passageways 21c via the air outlet 24c relatively. The inner unit 2b and the bottom unit 2c are joined together with their respective bases 26b and 26c.

### EXAMPLES

### Example 1

The impregnation system according to the present invention has been used to impregnate continuous fibers with a thermoplastic polymer at high line speed and provide a composite structure in which the reinforcing continuous fibers are uniformly distributed.

Commercial glass fiber direct roving (GFDR) SE4220 from 3B-Fibreglass was used as glass fiber strand input, made up of 19μ diameter filaments giving tex (g/km) of 3000. Each GFDR was placed on a free rotating disc mounted on a table to enable easy strand pulling. The unwinding of the GFDR was from outside to avoid any twists during unwinding. Total of six direct roving were used simultaneously for impregnation.

A spreader assembly unit according to the present invention was arranged in six channels, enabling six inlets for glass fiber strands from six direct rovings as shown in FIGS. 37 to 45. Each strand went through one inlet entrance of 6 mm×0.5 mm, which was also the start of the rectilinear part of the channel (inner channel), and exiting through respective outlet, each of 30 mm×0.7 mm, which was also the exit of the divergent part of the channel (divergent zone). Each of the six channels comprised rectilinear and divergent channel parts and had a total channel length of 60 mm, with a rectilinear channel part having dimensions of 20 mm×6 mm×0.5 mm followed immediately by a divergent channel part having 40 mm in length with a divergence angle of about 20.6°, leading to dimensions of 30 mm×0.7 mm for the exit. The air, at 1.5 bar pressure, was distributed to the six channels through their respective one air inlet hole, essentially perpendicularly to the channel. Each air inlet hole led to three finer holes of 1 mm diameter each, arranged across the channel width and located at a point immediately upstream of the entrance end of the divergent part, through which air entered into the fiber channel. The six channels of this unit were arranged such that the outlet exits gave in total a flat spread strand band of 70 mm width, which was guided into the impregnation die inlet with AR₃₀ of 50:1 (40 mm×0.8 mm). The fibers were pulled by a pulling/winding mechanism from the outlet exit of the impregnation die at a given speed. No broken filaments, no breaking of strands and no fuzz or line stoppages or interruptions were observed. The quality of spreading i.e. the spread width expected from the spreading unit settings, was assessed by measuring spread width and visually inspecting the spreading on the running line. Prior to entering into the impregnation die inlet, the moving spread fiber band was heated using a air flow heating gun set at 300° C.

As impregnating substance, thermoplastic injection molding grade Polypropylene with MFR (Melt Flow Rate, MFR expressed in g/10 min at 230° C. & 2.16 kg) of 45 and Mp around 160° was pre-granulated, using a twin ZSK30 extruder, with 1.2% by wt of commercially available maleic anhydride grafted Polypropylene grade Exxelor PO1020 having MFR of 430 g/10 min and Mp around 160° C. The pre-granulated thermoplastic matrix was fed into an single screw extruder, set to supply around 265-270 cm³/min of molten thermoplastic feed to the impregnation die of the present invention attached to its exit. The impregnation die inlet and outlet fixed at AR₃₀ of 50:1 (40 mm×0.8 mm), which also formed the passageway for spread fibers. The two outlets for impregnating substance, which intersected the fiber passageway inside the impregnation die, were set to AR₃₂₄ of 8:1 (40 mm×5 mm). The impregnation die was externally completely covered with heating plates to maintain the temperature at 300° C. The extruder was set to supply around 265-270 cm³/min of molten thermoplastic feed to the impregnation die attached to its exit and fiber puller speed of 20 m/min. The die output of glass filaments impregnated with molten thermoplastic resin showed 60% by wt of glass content and average thickness of around 0.5 mm.

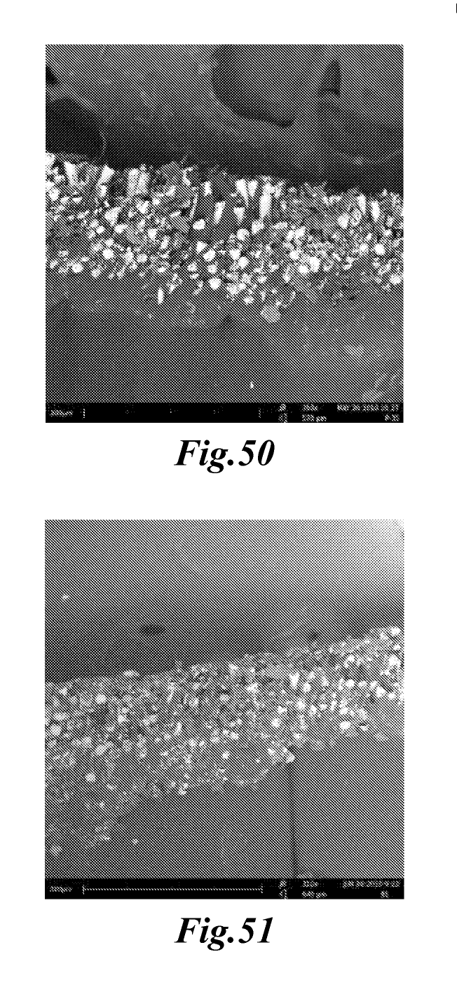

Further flattening or widening of the impregnated filaments was made possible by passing the output of glass filaments impregnated with molten thermoplastic resin over two ceramic rolls, maintained at 250° C. A tape with average width of 60 mm and average thickness around 0.33 mm after cooling was thus obtained. The cooling or quenching was done by press holding a cold, wet metal plate, moving at the same rate as the line speed, against the tape surface of the running tape. The microscopic (Phenom Microscope that was coupled high quality scanning electron microscope with optical camera from FEI Company, USA) pictures reveal good fiber dispersion within the thermoplastic matrix resin as shown in FIG. 50.

### Example 2

Like in example 1, same spreader assembly and impregnation die according to the invention have been used except that the impregnating substance was a proprietary Polyolefin composition with MFR around 15 g/10 min (190° C., 2.16 kg) with Mp around 128° C. The extruder was set to supply around 245-250 cm³/min of molten thermoplastic feed to the impregnation die attached to its exit and fiber puller speed of 20 m/min. After passing over the two ceramic rolls, maintained at 250° C., a tape with average width of 65 mm and average thickness around 0.29 mm after cooling was obtained with a glass content of around 62% by wt. The microscopic (Phenom Microscope that was coupled high quality scanning electron microscope with optical camera from FEI Company, USA) pictures reveal good fiber dispersion within the thermoplastic matrix resin as shown in FIG. 51.

### Example 3

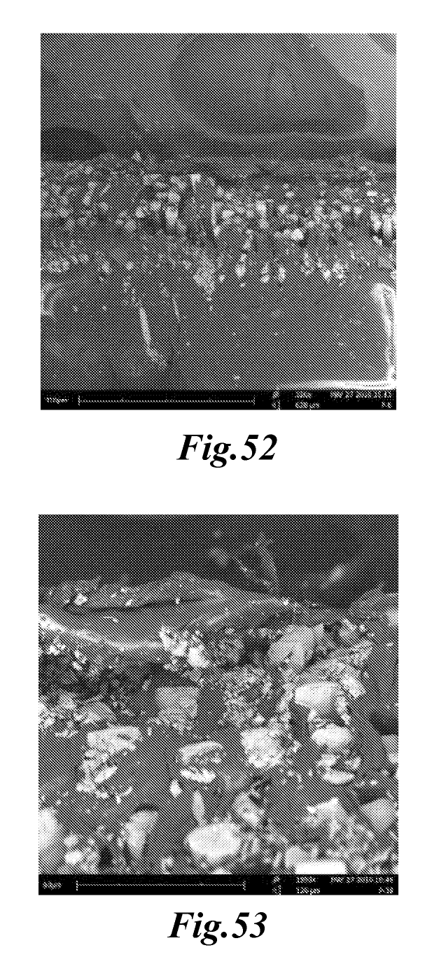

Like Example 1, the same impregnation die has been used but the spreader assembly of the invention was chosen with four channels to give a spread fiber band width of 60 mm. Thus, four strands of glass fiber direct roving were used. The extruder was set to supply around 285-290 cm³/min of molten thermoplastic feed to the impregnation die attached to its exit and fiber puller speed of 30 m/min. After passing over the two ceramic rolls, maintained at 250° C., a tape has been obtained that showed an average width of 46 mm and an average thickness of around 0.3 mm after cooling, with a glass content around 58% by wt. The microscopic (Phenom Microscope that was coupled with high quality scanning electron microscope with optical camera from FEI Company, USA) pictures reveal good fiber dispersion within the thermoplastic matrix resin as shown in FIGS. 52 and 53.

### Example 4

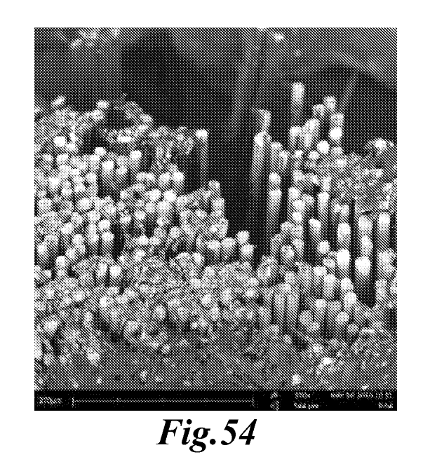

Like in example 3, except that one (lower) of the two outlet channels of the impregnating substance was completely closed by turning the screw. This allowed the impregnating substance to initially meet the spread fibers band only from the top and would, therefore, penetrate through the spread fibers only from the top surface of the spread fibers band. The extruder was set to supply around 285-290 cm3/min of molten thermoplastic feed to the impregnation die attached to its exit and fiber puller speed of 30 m/min. The output tape with apparently much less acceptable quality was observed compared to when the both outlets of impregnating substance were open. The example demonstrated the ineffectiveness of having impregnating substance from only one side under given conditions, at least in this example, where the impregnating substance was a thermoplastic matrix. The microscopic (Phenom Microscope that was coupled with high quality scanning electron microscope with optical camera from FEI Company, USA) pictures reveal that one side of the band was not properly surrounded by the impregnating substance as shown in FIG. 54.

1. An impregnation system suitable for impregnating filaments continuously with an impregnating substance, the system comprising an impregnation assembly comprising:
(a) at least one axial passageway for the filaments having an entrance end and an exit end; and
(b) at least one passageway for the impregnating substance having at least one inlet for the impregnating substance and at least two outlets for the impregnating substance,
wherein:
the axial passageway for the filaments has an oblong cross-section with an aspect ratio of at least 20:1, at the outlet point for the impregnating substance;
the at least two outlets for the impregnating substance have an oblong cross-section; and
are disposed essentially opposite to each other, at the opposite widths of the axial passageway for the filaments.

2. An impregnation system according to claim 1, wherein the axial passageway for the filaments has an oblong cross-section with an aspect ratio of at least 2:1 at the outlet for the impregnating substance.

3. An impregnation system according to claim 1 wherein the width of the outlet for the impregnating substance into the axial passageway for the filaments is essentially the same as the width of the axial passageway.

4. An impregnation system according to claim 1, wherein the at least two outlets for the impregnating substance into the axial passageway for the filaments have an oblong cross-section with an aspect ratio of at least 2:1.

5. An impregnation system according to claim 1 wherein the impregnation assembly further comprising:
(a) an inner die comprising:
a passage space for filaments;
a projection end; and
an entrance end, and
(b) an outer die comprising:
an inner space;
an exit passage;
an exit end; and
a passage for the impregnating substance,
wherein:
the inner die is positioned in the inner space of the outer die and the projection end of the inner die is positioned to form the outlets for the impregnating substance;
the axial passageway comprises:
the passage space of the inner die;
the exit passage of the outer die; and
the at least two outlets for the impregnating substance being opposite to each other,
said passage space 311 and said exit passage 322 being aligned in the direction of the filament passage.

6. An impregnation system according to claim 5, wherein the impregnation assembly further comprises at least one adjusting means for controlling the distance between the inner die and the outer die along the axial direction of the axial passageway so as to adjust the size or the aspect ratio of the at least two outlets for the impregnating substance.

7. An impregnation system according to claim 6, wherein the inner die comprises at least two die units disposed essentially opposite to each other and wherein each die unit is independently adjustable by adjusting means in each die unit.

8. An impregnation system according to claim 6, wherein the adjusting means comprises a screw assembly attaching the inner die to the outer die in an adjustable manner.

9. An impregnation system according to claim 6, wherein the adjusting means are pneumatic and/or hydraulic adjusting means.

10. An impregnation system according to claim 5, wherein the impregnation assembly further comprises a shaping die arranged immediately downstream of the exit passage of the outer die, the shaping die comprises at least two die units disposed essentially opposite to each other, and at least one die unit is slidably adjustable in an up or down movement by an adjusting means in the shaping die.

11. An impregnation system according to claim 10, wherein the adjusting means of the shaping die comprises an eccentric screw to adjust the distance between the opposite shaping die units.

12. An impregnation system according to claim 1 further comprising a spreader assembly arranged upstream of the impregnation assembly.

13. An impregnation system according to claim 12 wherein the spreader assembly comprises:
(a) at least one spreader passageway for filaments having an inlet opening for receiving filaments and an outlet opening through which the filaments exit said spreader passageway;
(b) a divergent zone within the spreader passageway having an entrance end and an exit end, wherein a cross-sectional area of the exit end is larger than a cross-sectional area of the entrance end and the divergent zone has an oblong cross-section with an aspect ratio of at least 2:1; and
(c) at least one through hole connected to the spreader passageway at an angle, substantially perpendicular with respect to the longitudinal direction of the spreader passageway, and suitable for introducing air flow thereto.

14. An impregnation system according to claim 13 wherein the though hole is connected to the spreader passageway through an outlet for air disposed adjacent to the entrance end of the divergent zone.

15. An impregnation system according to claim 14 wherein the outlet for air has one or more holes smaller than the dimension of the through hole.

16. An impregnation system according to claim 13 wherein said spreader passageway of the spreader assembly further comprises an inner channel having a rectilinear shape disposed between the inlet opening of the spreader passageway and the entrance end of the divergent zone.

17. An impregnation system according to claim 16, wherein the outlet for air is disposed within the inner channel at a point immediately upstream of the entrance end of the divergent zone.

18. An impregnation system according claim 13 wherein the divergent zone has a top wall, a bottom wall and sidewalls, wherein the sidewalls diverge outwardly from the entrance end toward the exit end, at an angle (α) from about 10° to about 50°.

19. A method of producing a reinforced composite structure comprising the steps of:
(a) supplying two or multiple filaments from one or more sources of continuous filaments;
(b) arranging said filaments in a plane having a cross-section with an aspect ratio of at least 20:1; and
(c) subjecting said filaments to at least two flows of an impregnating matrix substance sandwiching and impregnating the filaments within the impregnation system according to claim 1,
characterised in that the opposite flows are in the form of a layer having an oblong cross-section with an aspect ratio of at least 2:1, at the initial meeting point of the filaments and the impregnating matrix substance.

20. A method according to claim 19, wherein said filaments are subjected to at least two opposite flows of impregnating matrix substance at an angle (β) less than about 90°, with respect to the moving direction of the strand and/or filaments within the passageway.

21. A method according to claim 19, wherein the supplied impregnating substance is in liquid form selected from a group consisting of a solution, an emulsion, a suspension or a dispersion of said polymer in an aqueous or organic carrier, in molten form or in gel form inside the die at any given impregnating temperature.

22. A method according to claim 21, wherein the impregnating substance is a thermoplastic polymer selected from a group consisting of Polyolefins, Polyamides, Polyimides, Polyamide-imide, Polysulphones, Polyesters, Polycarbonates, Polyurethanes, Polyketones, Polyacrylates, Polystyrene, Polyvinylchloride, ABS, PC/ABS and a mixture thereof, or a thermosetting resin precursor selected from a group of Epoxy, Ester, Urethanes, Phenolic, Alkyd and a mixture thereof.

23. A method according to claim 19, wherein the filaments supplied at step (a) are selected from a group consisting of glass fibers, mineral fibers, carbon fibers, graphite fibers, natural fibers, ceramic fibers, metallic fibers, polymeric and synthetic fibers.

24. A method according to claim 19, wherein the filaments supplied at step (a) are coated by a sizing and/or binding agent.

25. A method according to claim 19 further comprising a step of pulling the sandwiched filaments with the impregnating substance through an exit passage having a substantially flat cross-section.

26. A method according to claim 19 further comprising a step of subjecting a strand and/or filaments supplied at step (a) to air flow at an angle, substantially perpendicularly to the moving direction of the strand and/or filaments within a passageway of a spreader assembly.

27. A method according to claim 26 wherein the strand and/or filaments are subjected to the air flow through at least one hole disposed at the one end of a through hole connecting to the passageway, wherein the passageway comprises an inlet opening for receiving said fiber strand and/or filaments, an outlet opening through which said strand and/or filaments exit the passageway, and a divergent zone having an entrance end and an exit end wherein the area of said exit end is larger than the area of the said entrance end.

28. A method according to claim 27 wherein the strand and/or filaments are subjected to the air flow within an inner channel having a rectilinear shape which is disposed between the inlet opening of the passageway and the entrance end of the divergent zone, disposed at a point immediately upstream from the entrance end of the divergent zone.

29. A method according to claim 19 further comprising a step of heating the strand and/or filaments prior to step (c).

30. A method according to claim 19 further comprising steps of:
flattening the impregnated fibers provided by step (c); and thereafter
winding up the impregnated fibers onto a winding core.

31. A method according to claim 19 further comprising steps of:
shaping the impregnated fibers provided by step (c) collectively into a rod; and thereafter
cutting the rod to desired length

32. A reinforced composite structure obtainable by the method according to claim 19.

33. A use of the impregnation system according to claim 1 for continuously impregnating filaments with an impregnating substance.
